(19) United States
(12) Patent Application Publication
(10) Pub. No.: US 2006/0279478 A1
(43) Pub. Date: Dec. 14, 2006

(54) LIGHT-EMITTING DEVICE, DRIVING METHOD THEREOF, AND ELECTRONIC APPARATUS

(75) Inventor: Tomio IKEGAMI, Suwa-shi, Nagano-ken (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 11/381,465

(22) Filed: May 3, 2006

(30) Foreign Application Priority Data
Jun. 9, 2005 (JP) 2005-169171
Dec. 12, 2005 (JP) 2005-357270

(51) Int. Cl. G09G 3/00

(52) U.S. Cl. 345/30

(57) ABSTRACT

There are provided a light-emitting device and a driving method thereof capable of suppressing an image blur and a flicker. The light-emitting device includes: a display unit in which a plurality of pixel circuits for allowing light-emitting elements to emit light with brightness corresponding to a data signal is arranged; an image acquiring unit for acquiring a first image and a second image corresponding to times different from each other in a frame period of time, respectively; a data-line driving unit for supplying a data signal corresponding to the first image to the pixel circuits belonging to a first group among the plurality of pixel circuits and supplying a data signal corresponding to the second image to the pixel circuits belonging to a second group other than the first group; and a light-emission control unit for allowing the light-emitting elements of the pixel circuits belonging to the first group to emit light in a first period of the frame period of time and allowing the light-emitting elements of the pixel circuits belonging to the second group to emit light in a second period other than the first period of the frame period of time.

### BACKGROUND

1. Technical Field

The present invention relates to a technology of controlling behaviors of light-emitting elements such as organic light emitting diodes (hereinafter, referred to as OLED).

2. Related Art

There have been suggested light-emitting devices for displaying an image by controlling brightness of light-emitting elements arranged two-dimensionally. Among such light-emitting devices, a light-emitting device in which the light emission of the light-emitting elements is retained for the almost entire time length of a frame period is called a hold type light-emitting device.

As disclosed in a non-patent document entitled “TIME RESPONSE OF DISPLAY AND IMPROVEMENT IN IMAGE QUALITY OF MOVING PICTURE”, IEICE Tech. Rep., ELD 2001-84, pp. 13-18 (2001-01), Kurita Soichiro/The Institute of Electronics, Information and Communication Engineers (see FIG. 3), in the hold-type display device, there occurs a phenomenon (hereinafter, referred to as image blur) that the outline of an object recognized by an observer becomes unclear due to the difference between the movement of the object included in an image and the movement of a viewing point of the observer tracing the movement of the object. As a method of solving the image blur, there is known a method of allowing the light-emitting elements intermittently emit light as in an impulse type display device represented by a cathode ray tube (CRT) as well as maintaining the gray scales of the light-emitting elements for the whole time length of a frame period.

### SUMMARY

However, a phenomenon called “flicker” that the whole brightness of an image is periodically varied becomes remarkable due to a gap between the periods for lighting the light-emitting elements. An advantage of the invention is to suppress both an image blur and a flicker.

According to an aspect of the invention, there is provided a light-emitting device comprising: a display unit in which a plurality of pixel circuits for allowing light-emitting elements to emit light with brightness corresponding to a data signal is arranged; an image acquiring unit (for example, image processing unit 10 in embodiments of the invention) for acquiring a first image and a second image corresponding to times different from each other in a frame period of time, respectively; a data-line driving unit for supplying a data signal corresponding to the first image to the pixel circuits belonging to a first group among the plurality of pixel circuits and supplying a data signal corresponding to the second image to the pixel circuits belonging to a second group other than the first group; and a light-emission control unit for allowing the light-emitting elements of the pixel circuits belonging to the first group to emit light in a first period of the frame period of time and allowing the light-emitting elements of the pixel circuits belonging to the second group to emit light in a second period other than the first period of the frame period of time.

According to the configuration, paying attention to an area including the pixel circuits of the first group and the pixel circuits of the second group, the substantial cycle of light emission of the light-emitting elements is elongated in comparison with the configuration that the light-emitting elements emit light and extinguish light every frame period without partitioning into the first period and the second period. Accordingly, it is possible to suppress the flickers. In addition, the images displayed in the first period and the second period are images corresponding to the times different from each other in a frame period. Accordingly, it is possible to suppress the image blur in comparison with the configuration that the image displayed on the display unit is maintained for the frame period.

In the invention, the total number of groups into which the display unit is partitioned is arbitrary. For example, in a configuration that a plurality of pixel circuits arranged on the display unit are partitioned into three or more groups, the images corresponding to the groups are acquired by the image acquiring unit, the pixel circuits of each group are supplied with the data signals of the image corresponding to the group, and the light-emitting elements of the pixel circuits of each group are allowed to emit light by the light-emission control unit in the periods determined by groups in a frame period. Such a configuration that the pixel circuits of the display unit are partitioned into three or more groups does not depart from the scope of the invention by assuming one group as the first group and another group as the second group, without paying attention to the other groups.

The distribution pattern of the pixel circuits belonging to the respective groups is arbitrary. However, in consideration of easiness in arrangement of the lines for driving the pixel circuits or in control of the pixel circuits, the configuration that the display unit is partitioned in a plurality of unit areas in which the arrangement of the pixel circuits included in the respective groups is common is more preferable than the configuration that a plurality of pixel circuits is irregularly partitioned into groups. For example, when the display unit has a configuration that a plurality of circuit groups, each of which include a predetermined number of pixel circuits arranged in a first direction, are arranged in a second direction intersecting the first direction (for example, when a plurality of rows, each of which includes a predetermined number of pixel circuits arranged in an X direction, is arranged in the Y direction perpendicular to the X direction), each unit area may include the circuit group belonging to the first group and the circuit group being adjacent to the circuit group and belonging to the second group, and the light-emission control unit may allow the light-emitting elements of the pixel circuits to emit light or extinguish light by supplying a common light-emission control signal to the pixel circuits of one circuit group (for example, a first embodiment and a second embodiment). More specifically, the pixel circuits in odd circuit groups among a plurality of circuit group belong to the first group and the pixel circuits in even circuit groups belong to the second group. The light-emission control means allows the light-emitting elements of the pixel circuits to emit light or extinguish light by supplying a common light-emission control signal to the pixel circuits of one circuit group (for example, the first embodiment). According to the configuration that the light-emitting elements are partitioned into the first group and the second group in a unit of light-emitting elements arranged in the first direction, it is possible to control the light-emitting elements arranged in the first direction by the use of the common light-emission control signal. In addition, since the pixel circuits of each group are distributed discretely in the second direction, it is possible to more effectively suppress the flicker.

Above all, it is not necessary to partition the pixel circuits into groups in one of the first direction and the second direction, but for example, a plurality of pixel circuits may be partitioned into the groups so that the pixel circuits of the second group are adjacent to the pixel circuits of the first group in the first direction and the second direction (for example, the third embodiment to be described later). In other words, the plurality of pixel circuits may be partitioned into the first and second groups so that a checker board pattern is displayed when the light-emitting elements of one of the first group and the second group are allowed to emit light and the light-emitting elements of the other are allowed to extinguish light. According to this configuration, since the pixel circuits of the respective groups are distributed discretely in the first direction and the second direction, it is possible to more satisfactorily suppress the flicker in comparison with the configuration that the pixel circuits are partition into groups by arrangement of the pixel circuits in one of the first direction and the second direction.

Such a configuration that the pixel circuits partitioned into the groups in the checker board pattern can be embodied by properly selecting the connection states between the lines for supplying the light-emission control signals and the pixel circuits. That is, for example, as shown in FIG. 15 or 31, the pixel circuits of the first group in one circuit group among a plurality of circuit groups and the pixel circuits of the first group in a different circuit group adjacent to the circuit group may be connected in common to the first light-emission control line, the pixel circuits of the second group in one circuit group and the pixel circuits of the second group in the different circuit group may be connected in common to the second light-emission line, and the light-emission control unit may allow the light-emitting elements of the pixel circuits to emit light or extinguish light by supplying the light-emission control signals through the light-emission control lines. According to this configuration, it is possible to obtain the desired advantages of the invention without generating the light-emission control signals in a complicated manner.

The shapes of the lines relating to the pixel circuits can be properly modified. For example, in an exemplary aspect of the invention, the display unit may have a configuration that a plurality of line pairs, each of which includes a scanning line extending in a first direction (for example, the X direction in FIGS. 23 and 29) and a light-emission control line extending in the first direction, are arranged in a second direction (for example, the Y direction in FIGS. 23 and 29) intersecting the first direction, a circuit group (for example, a set of pixel circuits belonging to the respective rows) including a predetermined number of pixel circuits arranged in the first direction may be disposed between the line pairs adjacent to each other in the second direction, the pixel circuits of the first group in the respective circuit groups may be connected to the scanning line and the light-emission control line of the line pair adjacent to one side in the second direction as seen from the circuit group side, the pixel circuits of the second group may be connected to the scanning line and the light-emission control line of the line pair adjacent to the other side in the second direction as seen from the circuit group, a selection unit for sequentially selecting the scanning lines may be further provided, the data signal output from the data-line driving unit may be supplied to the pixel circuits connected to the scanning a line selected by the selection unit, and the light-emission control unit may allow the light-emitting elements of the pixel circuits to emit light or extinguish light by supplying a light-emission control signal through the light-emission control lines. According to this configuration, since the respective pixel circuits are connected to the scanning line or the light-emission control line adjacent thereto, it is possible to simplify the lines for connecting the pixel circuits to the scanning lines or the light-emission control lines. The specific example of the configuration will be described later in the fourth embodiment (FIGS. 21 to 29).

In this case, the data signal may be supplied to the pixel circuits through data lines extending in the second direction on an insulating layer covering the scanning lines and the light-emission control lines, first wiring portions (for example, wiring portions 511 in FIGS. 23 and 29) for electrically connecting the pixel circuits to the scanning lines and second wiring portions (for example, wiring portions 531 in FIGS. 23 and 29) for electrically connecting the pixel circuits to the light-emission control lines may be formed in the same layer as the data lines on the insulating layer. Here, the first wiring portions may extend in the second direction in the pixel circuits and may be electrically connected to the scanning lines through contact holes (for example, contact holes CH1 in FIGS. 23 and 29) of the insulating layer, respectively, and the second wiring portions may extend in the second direction in the pixel circuits and may be electrically connected to the light-emission control lines through contact holes (for example, contact holes CH2 in FIGS. 23 and 29) of the insulating layer.

According to this configuration, since the first wiring portions or the second wiring portions are formed in the same layer as the data lines, it is possible to save the manufacturing cost and to simplify the manufacturing processes in comparison with the configuration that they are formed in different layers. In addition, since the pixel circuits are connected to the scanning line or light-emission control line adjacent thereto, the places where the first wiring portions or the second wiring portions overlap with the scanning lines with an insulating layer therebetween. Accordingly, it is possible to control the capacitive coupling (parasitic capacitance) between the lines. In the invention, if a plurality of elements is “formed in the same layer,” it means that a plurality of elements is formed by the same process of selectively removing a common film (regardless of a single layer or a multi layer).

The relation between the time of supplying the data signals to the pixel circuits and the time of allowing the light-emitting elements of the pixel circuits to emit light with brightness corresponding to the data signals is arbitrary. For example, a configuration that the data signals are supplied to all the pixel circuit regardless of the partitioning of groups, the light-emitting a elements of the first group are allowed to emit light in the first period, and the light-emitting elements of the second group are allowed to emit light in the second period may be employed. However, when the time length from the time of supplying the data signals to the time of the actual emission of light is varied in the pixel circuits of the respective groups, the brightness may be deviated. Accordingly, in an exemplary aspect of the invention, the data-line driving unit may supply the data signals to the pixel circuits of the first group at the time before the pixel circuits of the first group emit light in the first period, and may supply the data signals to the pixel circuits of the second group at the time before the pixel circuits of the second group emit light in the second period. According to this configuration, since the time length from the time of supplying the data signals to the time of the actual emission of light is constant in the pixel circuits, it is possible to suppress the deviation in brightness.

In the invention, the method of allowing the image acquiring unit to acquire the images is not particularly limited. For example, a configuration of acquiring the images through reception of data from the outside may be employed. The image acquiring unit may generate the images on the basis of the data received from the outside. That is, in this configuration, the image acquiring unit may comprise: an intermediate image generator for generating an intermediate image from a first original image and a second original image which should be displayed in the successive frame periods of time; and a controller for notifying the data-line driving unit of one of a plurality of images including the intermediate image generated by the intermediate image generator as the first image and notifying the data-line driving unit of another image as the second image. In this configuration, both the intermediate image and the original image may be supplied to the data-line driving unit, or only the intermediate image generated by the intermediate image generator may be supplied to the data-line driving unit.

According to another aspect of the invention, there is provided an electronic apparatus comprising the light-emitting device according to any one of the above-mentioned aspects. A typical example of such an electronic apparatus is an apparatus using the light-emitting device as a display device. Examples of such a kind of electronic apparatus can include a personal computer and a mobile phone.

The invention can be specified as a method of driving the light-emitting device. According to another aspect of the invention, there is provided a method of driving a light-emitting device in which a plurality of pixel circuits for allowing light-emitting elements to emit light with brightness corresponding to a data signal is arranged in a matrix shape, the method comprising: acquiring a first image and a second image corresponding to times different from each other in a frame period of time, respectively; supplying a data signal corresponding to the first image to the pixel circuits belonging to a first group among the plurality of pixel circuits and supplying a data signal corresponding to the second image to the pixel circuits belonging to a second group other than the first group; and allowing the light-emitting elements of the pixel circuits belonging to the first group to emit light in a first period of the frame period of time and allowing the light-emitting elements of the pixel circuits belonging to the second group to emit light in a second period other than the first period of the frame period of time. According to the method described above, it is possible to obtain the same advantages as the light-emitting device according to the invention.

### BRIEF DESCRIPTION OF THE DRAWINGS

The invention will be described with reference to the accompanying drawings, wherein like numbers reference like elements.

FIG. 1 is a block diagram illustrating a configuration of a light-emitting device according to a first embodiment of the invention.

FIG. 2 is a timing diagram illustrating operations of a selection circuit and a light-emission control circuit.

FIG. 3 is a circuit diagram illustrating a configuration of a pixel circuit.

FIG. 4 is a conceptual diagram illustrating the whole operation of the light-emitting device.

FIG. 5 is a conceptual diagram illustrating an operation of a controller in an image processing unit.

FIG. 6 is a timing diagram illustrating operations of a data-line driving circuit and a selection circuit.

FIGS. 7A to 7C are conceptual diagrams illustrating a principle of generating an image blur on the basis of a comparative example.

FIGS. 8A to 8C are conceptual diagrams illustrating a principle of suppressing an image blur according to the first embodiment.

FIG. 9 is a diagram illustrating a partition method into groups according to a second embodiment of the invention.

FIG. 10 is a conceptual diagram illustrating the whole operation of a light-emitting device.

FIG. 11 is a timing diagram illustrating operations of a data-line driving circuit and a selection circuit.

FIG. 12 is a timing diagram illustrating operations or the selection circuit and a light-emission control circuit.

FIG. 13 is a diagram illustrating a partition method into groups according to a third embodiment of the invention.

FIG. 14 is a conceptual diagram illustrating the whole operation of a light-emitting device.

FIG. 15 is a block diagram illustrating a configuration of a display unit

FIGS. 16A and 16B are diagrams illustrating a lighting and extinction pattern of light-emitting elements.

FIGS. 17A and 17B are diagrams illustrating a lighting and extinction pattern of the light-emitting elements.

FIGS. 18A and 18B are diagrams illustrating a lighting and extinction pattern of the light-emitting elements.

FIGS. 19A and 19B are diagrams illustrating a lighting and extinction pattern of the light-emitting elements.

FIGS. 20A and 20B are diagrams illustrating a lighting and extinction pattern of the light-emitting elements.

FIG. 21 is a block diagram illustrating a configuration of a display unit according to a fourth embodiment of the invention.

FIG. 22 is a timing diagram illustrating waveforms of scanning signals and light-emission control signals.

FIG. 23 is a plan view illustrating a layout of elements in the display unit.

FIGS. 24A and 24B are diagrams illustrating a lighting pattern of the light-emitting elements according to a first aspect.

FIG. 25 is a timing diagram illustrating waveforms of scanning signals and light-emission control signals.

FIG. 26 is a conceptual diagram illustrating the whole operation of the light-emitting device.

FIGS. 27A and 27B are diagrams illustrating a lighting pattern of the light-emitting elements according to a second aspect.

FIG. 28 is a block diagram illustrating a configuration of a display unit.

FIG. 29 is a plan view illustrating a layout of elements in the display unit.

FIG. 30 is a timing chart illustrating operations of a selection circuit and a light-emission control circuit.

FIG. 31 is a block diagram illustrating a configuration of a display unit according to a modified example.

FIG. 32 is a block diagram illustrating a configuration of a display unit according to a modified example.

FIG. 33 is a plan view illustrating a layout of elements in a display unit.

FIG. 34 is a perspective view illustrating a specific example of an electronic apparatus according to the invention.

FIG. 35 is a perspective view illustrating a specific example of an electronic apparatus according to the invention.

FIG. 36 is a perspective view illustrating a specific example of an electronic apparatus according to the invention.

### DESCRIPTION OF EXEMPLARY EMBODIMENTS

### A: First Embodiment

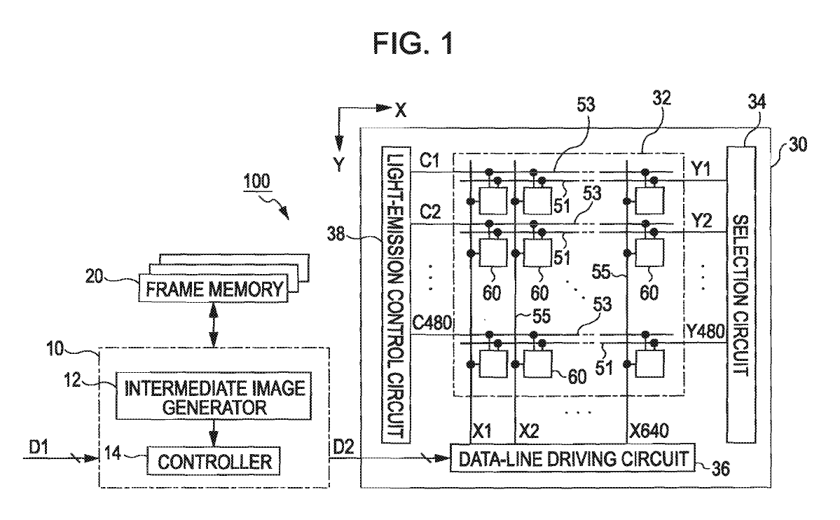

FIG. 1 is a block diagram illustrating a configuration of a light-emitting device according to a first embodiment of the present invention. As shown in FIG. 1, the light-emitting device 100 has an image processing unit 10, a frame memory 20, and a display panel 30. The image processing unit 10 serves to generate second image data D2 from first image data D1. The first image data D1 are digital data indicating details (colors and gray scales of pixels) of frame images constituting a moving image and are supplied from a generic unit such as a CPU of an electronic apparatus mounted with the light-emitting device 100. On the other hand, the second image data D2 are digital data indicating details of an image to be substantially displayed on the display panel 30. The configuration and operation of the image processing unit 10 will be described in detail later.

The display panel 30 serves to display an image on the basis of the second image data D2 and includes a display unit 32 in which a plurality of pixel circuits 60 are two-dimensionally arranged and driving circuits (for example, a selection circuit 34, a data-line driving circuit 36, and a light-emission control circuit 38) for driving the pixel circuits 60 on the basis of the second image data D2. The driving circuits or the image processing unit 10 may be mounted in the form of an IC chip on the surface of a substrate on which the pixel circuits 60 are arranged or on a printed circuit board connected to the substrate, or may be constructed by switching elements (typically, thin film transistors) directly formed on the surface of the substrate.

480 scanning lines 51 extending in the X direction (row direction), 480 light-emission control lines 53 extending to form a pair with the scanning lines 51, and 640 data lines 55 extending in the Y direction (column direction) perpendicular to the X direction are formed on the display unit 32. The pixel circuits 60 are disposed at positions corresponding to intersections between the pairs of the scanning line 51 and the light-emission control line 53 and the data lines 55, respectively. Therefore, the pixel circuits 60 are arranged in a matrix form of 480 rows×640 columns. However, the total number and the form of arrangement of the pixel circuits 60 are not limited to the example described above.

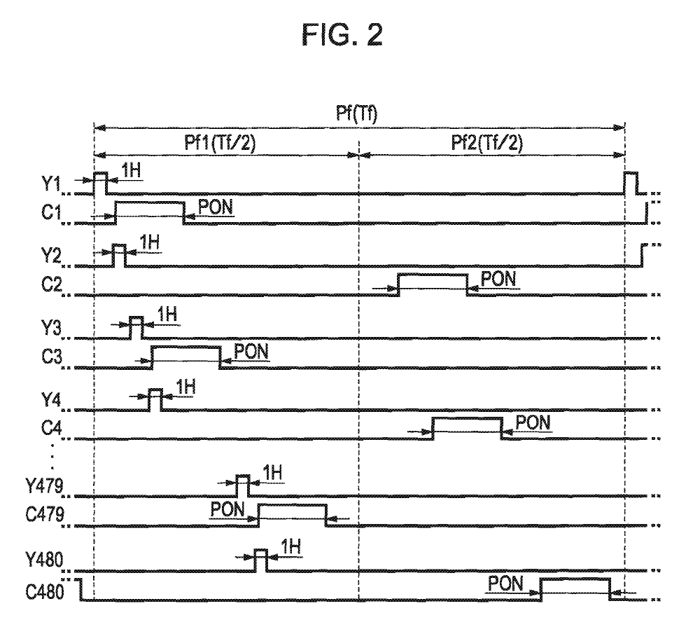

The driving circuits include a selection circuit 34, a data-line driving circuit 36, and a light-emission control circuit 38. The selection circuit 34 supplies scanning signals Y (Y1, Y2, . . . , Y480) for sequentially selecting the scanning lines 51 to the scanning lines 51. More specifically, among a first period Pf1 and a second period Pf2 which are obtained by dividing a frame period of time Pf into two halves as shown in FIG. 2, the selection circuit 34 sequentially selects the scanning lines 51 every horizontal scanning period 1H of the first period Pf1, changes the scanning signals Y supplied to the selected scanning lines 51 to a high level, and maintains the scanning signals Y supplied to the non-selected scanning lines 51. On the other hand, as shovel in FIG. 2, the light-emission control circuit 38 generates light-emission control signals C (C1, C2, . . . , C480) for defining periods (hereinafter, referred to as light-emission period) Pon when the pixel circuits 60 in each row emit light in each frame period Pf and outputs the light-emission control signals to the light-emission control lines 53. The selection circuit 34 and the light-emission control circuit 38 constitute a scanning-line driving circuit (Y driver).

The data-line driving circuit 36 supplies data signals X (X1, X2, . . . , X640) to 640 pixel circuits 60 belonging to the row selected by the selection circuit 34 through the data lines 55. The data signals X supplied to the pixel circuits 60 are current-amount signals corresponding to the gray scales designated for the corresponding pixel circuits on the basis of the second image data D2.

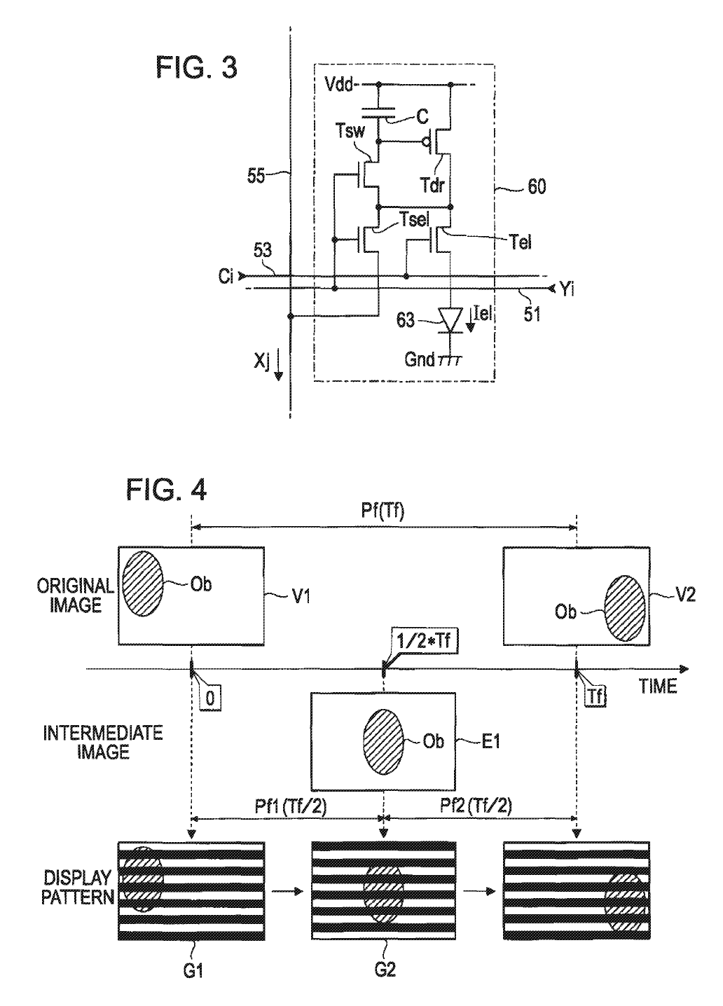

FIG. 3 is a circuit diagram illustrating a configuration of one pixel circuit 60. In the figure, only the pixel circuit 60 corresponding to row i (where i is an integer satisfying 1≦i≦480) and column j (where i is an integer satisfying 1≦j≦640) is shown, but the other pixel circuits 60 have the same configuration.

As shown in FIG. 3, the pixel circuit 60 includes a p-channel driving transistor Tdr, three n-channel transistors (a light-emission control transistor Tel, a selection transistor Tsel, and a switching transistor Tsw), a capacitive element C for retaining a voltage, and a light-emitting element 63d interposed between a power supply line through which a high potential Vdd is supplied from a power source and a ground line through which a low potential Gnd is supplied. The light-emitting element 63 is an OLED element in which a light-emitting layer made of an organic EL material is interposed between a positive electrode and a negative electrode, and emits light with a gray scale (brightness corresponding to the amount of driving current Iel.

The driving transistor Tdr serves to control the amount of the driving current Iel, the source is connected to the power supply line through which the high potential Vdd is supplied, and the drain is connected to the drain of the light-emission control transistor Tel. The light-emission control transistor Tel is a switching element for defining the light-emission period Pon when the driving current Iel is substantially supplied to the light-emitting element 63, the source is connected to the positive electrode of the light-emitting element 63, and the gate is connected to the light-emission control line 53.

On the other hand, the switching transistor Tsw is a switching element interposed between the gate and the drain of the driving transistor Tdr and the gate thereof is connected to the scanning line 51 along with the selection transistor Tsel. The selection transistor Tsel is a switching element for switching the electrical connection between the drain of the driving transistor Tdr and the data line 55.

In the configuration described above, when the scanning signal Yi is changed to a high level, the switching transistor Tsw is changed to the ON state and thus the driving transistor Tdr is diode-connected. At this time, since the selection transistor Tsel is in the ON state, current of the data signal Xj flows to the data line 55 through the driving transistor Tdr and the selection transistor Tsel from the power supply line. Accordingly, electric charges corresponding to the gate potential of the driving transistor Tdr (electric charges corresponding to the data signal Xj) are accumulated in the capacitive element C.

On the other hand, when the scanning signal Yi is changed to a low level, the switching transistor Tsw and the selection transistor Tsel are simultaneously turned off. Accordingly, the gate-source voltage of the driving transistor Tdr is retained as the voltage corresponding to the electric charges accumulated in the capacitive element C for the horizontal scanning period right before. In this state, when the light-emission control signal Ci is changed to the high level, the light-emission control transistor Tel is changed to the ON state and as a result, the driving current corresponding to the gate potential of the driving transistor Tdr (that is, current corresponding to the amount of current of the data signal Xj) Iel is supplied to the light-emitting element 63 through the driving transistor Tdr and the light-emission control transistor Tel from the power supply line. Then, the light-emission element 63 emits light with brightness in proportion to the driving current Iel. As described above, by controlling the brightness of the light-emitting element 63 in a unit of pixel circuit 60, a desired image corresponding to the second image data D2 is displayed on the display unit 32.

Specific configuration and operation of the image processing unit 10 will be described now. As shown in FIG. 1, the image processing unit 10 includes an intermediate image generator 12 and a controller 14. The intermediate image generator 12 generates an intermediate-state image (hereinafter, referred to as an intermediate image) of successive original images by interpolating frame images (hereinafter, may be also referred to as original images) expressed by the first image data D1.

FIG. 4 is an explanatory diagram illustrating a detailed operation of the image processing unit 10. The first image data D1 corresponding to the original images V1 and V2 are sequentially supplied to the image processing unit 10 every frame period Pf (of which the time length Tf is, for example, 1/60 second) and then are stored in the frame memory 20. The intermediate image generator 12 generates an intermediate image E1 at the time “½×Tf” when a half time length of the frame period Pf has passed from the time “0” when the original image V1 should be displayed, on the basis of the first image data D1 of the original image V1 and the original image V2 which are successive, and stores the generated intermediate image in the frame memory 20. For example, the intermediate image generator 12 generates the intermediate image E1 from the motion vector of an object Ob extracted from the original image V1 and the original image V2. The intermediate image E1 is an image in which the object Ob is disposed almost at the center position between the position of the object Ob in the original image V1 and the position of the object Ob in the original image V2. In addition, the method of generating the intermediate image E1 is not limited to the method described above, but may employ all the well-known methods.

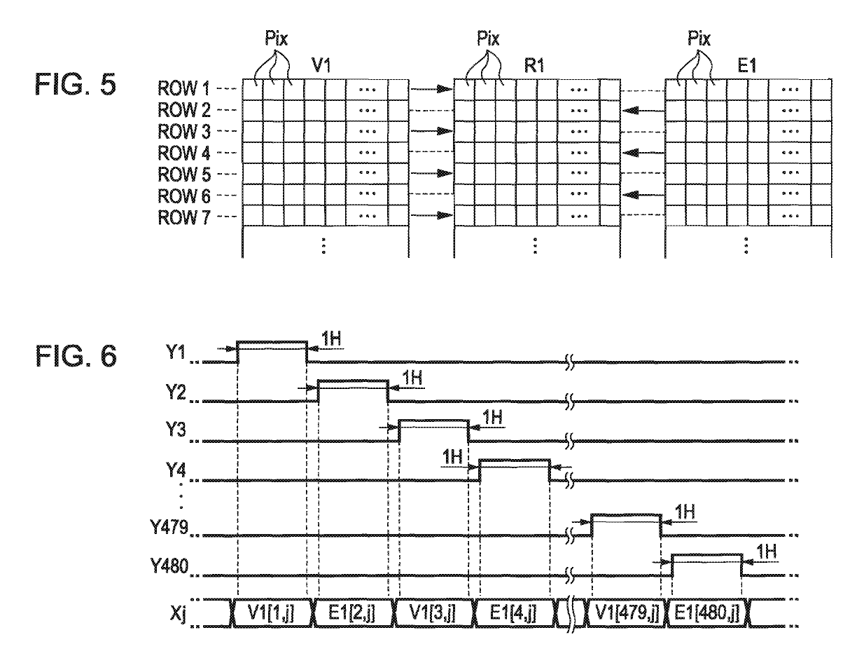

On the other hand, the controller 14 shown in FIG. 1 generates second image data D2 from the first image data D1 of the original image V1 and the image data of the intermediate image E1 and outputs the generated second image data to the data-line driving circuit 36. As shown in FIG. 5, the second image data D2 are data indicating an image R1 in which the pixels Pix belonging to the odd rows of the original image V1 and the pixels Pix belonging to the even rows of the intermediate image E1 are alternately arranged. That is, in the image R1 expressed by the second image data D2, the pixels Pix belonging to the first row correspond to the first row of the original image V1, the pixels Pix belonging to the second row correspond to the second row of the intermediate image E1, and the pixels Pix belonging to the third row correspond to the third row of the original image V1.

FIG. 6 is a timing diagram illustrating a relation between an operation of the data-line driving circuit 36 for outputting the data signal Xj on the basis of the second image data D2 generated in the above-mentioned order and a selecting operation of the selection circuit 34. As shown in the figure, for the horizontal scanning period selected by the odd-row scanning line 51, the data signal Xj corresponding to the odd-row pixels V1(1,j), V1(3,j), V1(479,j) of the original image V1 is supplied to the pixel circuits 60 in the selected row (odd row). On the other hand, the data signal Xj corresponding to the even-row pixels E1(2,j), E1(4,j), . . . , E1(480,j) of the intermediate image E1 is supplied to the pixel circuits 60 in the selected row (even row).

On the other hand, the light-emission control circuit 38 generates the light-emission control signals C1 to C480 so that the light-emitting elements 63 of the pixel circuits 60 in the odd rows emit light in a first period Pf1 which is a first half of the frame period Pf and the light-emitting elements 63 of the pixel circuits 60 in the even rows emit light in a second period Pf2 which is a second half, and outputs the generated light-emission control signals to the light-emission control lines 53. More specifically, as shown in FIG. 2, when the scanning signals Y2k+1 supplied to the scanning lines 51 of the odd rows (row 2k+1) in the first period Pf1 is changed to the low level from the high level (where k is an integer satisfying 0≦k≦239 in the first embodiment), the light-emission control circuit 38 maintains the light-emission control signals C2k+1 supplied to the light-emission control lines 53 forming pairs along with the scanning lines 51, respectively, at a high level for the light-emission period Pon. In addition, the light-emission control circuit 38 maintains the light-emission control signals C2k+2 supplied to the light-emission control lines 53 in the even rows at the low level in the first period Pf1. On the other hand, in the second period Pf2, the light-emission control circuit 38 changes the light-emission control signals C2k+2 supplied to the light-emission control lines 53 in the even rows (rows 2k+2) to the high level for the light-emission period Pon and maintains the light-emission control signals C2k+1 at the low level.

As a result of operations described above, in the first period Pf1 shown in FIG. 2, as indicated by an image G1 in FIG. 4, the pixels in the odd rows of the original image V1 are displayed by the light-emitting elements 63 in the odd rows lighted by the light-emission signals C2k+1 of the high level, and the light-emitting elements 63 in the even rows are extinguished by the light-emission control signals C2k+2 of the low level (the area hatched in the figure). On the other hand, in the second period Pf2, as indicated by an image G2 in FIG. 4, the pixels in the even rows of the intermediate image E1 are displayed by the light-emitting elements 63 in the even rows lighted by the light-emission signals C2k+2 of the high level, and the light-emitting elements 63 in the odd rows are extinguished by the light-emission control signals C2k+1 of the low level. The above-mentioned operations are repeated every frame period Pf.

Here, when the hold type display in which the light emission of the light-emitting elements 63 is maintained all over the frame period Pf is not used and a type in which the light-emitting elements 63 are allowed to intermittently emit light is used, flickers may become remarkable due to the periodical generation of lighting and extinction of the light-emitting elements 63. As a countermeasure for suppressing the flickers resulting from the intermittent light emission, the enhancement in frame rate (that is, decrease in cycle of lighting and extinction) can be considered. In the first embodiment, the pixel circuits 60 in the odd rows sequentially emit light in the first period Pf1 of the frame period Pf and the pixel circuits 60 in the even rows sequentially emit light in the second period Pf2 of the frame period Pf. That is, supposed that two rows adjacent to each other in the Y direction form a unit (block), the lighting and extinction are repeated in almost the half time of the frame period Pf assigned to the first image data D1. Accordingly, according to the first embodiment, it is possible to suppress the flickers, which are recognized by an observer, so as to be equal to that of the case that the frame rate of the display panel 30 is substantially enhanced.

In order to obtain the above-mentioned result, a configuration (hereinafter, referred to as comparative example) that the original image V1 or V2 is displayed by the use of the pixel circuits 60 in the odd rows and the pixel circuits 60 in the even rows can be also considered. That is, the first image data D1 specifying the original images V1 and V2 are supplied to the data-line driving circuit 36, the pixels in the odd rows of the original image are displayed by the light emission of the pixel circuits 60 in the odd rows in the first period Pf1, and the pixels in the even rows of the original image are displayed by the pixel circuits 60 in the even rows in the second period Pf2. However, in the comparative example, there is a problem that image blurs which are recognized by an observer, becomes remarkable. This problem is described in detail below.

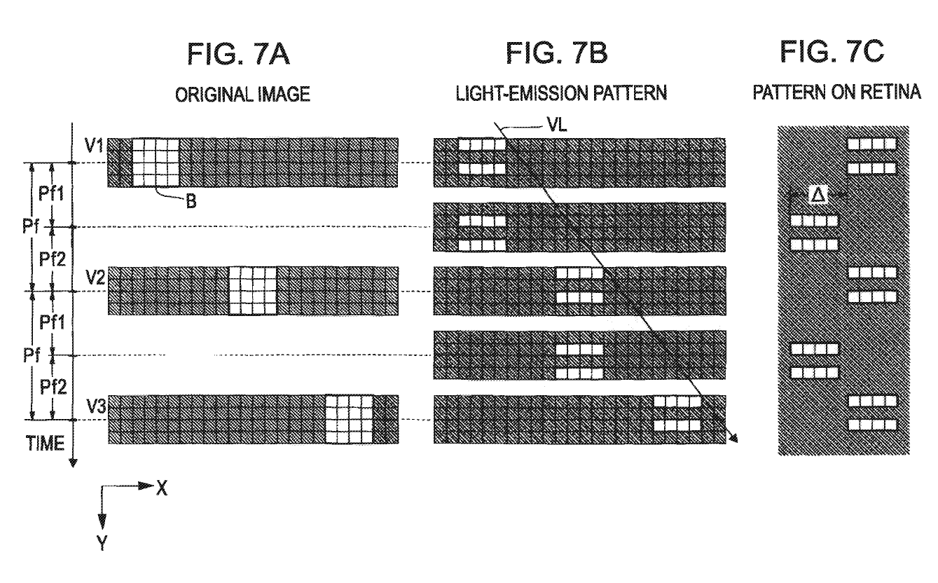

FIG. 7A is a diagram illustrating patterns of the original images V1, V2, and V3 indicated by the pixel circuits 60 of 4 rows×24 columns and FIG. 7B is a diagram illustrating patterns displayed on the display panel 30 in the first period Pf1 and the second period Pf2 of each frame Pf. In FIG. 7A, the vertical axis denotes time. Here, it is assumed that an object B displayed by the light emission of the light-emitting elements 63 is moved to right by 8 pixels every frame period Pf on the background of black color (hatched area).

As shown in FIG. 7A, display of one original image V1 to V3 is instructed to the pixel circuits 60 from the start point to the end point of one frame period Pf. As shown in FIG. 7B, in the first period Pf1 of the frame period Pf, the pixels in the odd rows of the original image are displayed by the light emission of the light-emitting elements 63 in the odd rows and in the second period Pf2, the pixels in the even rows of the original image are displayed by the light emission or the light-emitting elements 63 in the even rows.

On the other hand, an observer viewing the image moves the viewing point to follow the movement of the object B. Now, supposed that the viewing point is moved sufficiently smoothly to follow the movement of the object B, the viewing point of the observer is continuously moved to right at an almost constant speed to follow the object B, as indicated by an arrow VL in FIG. 7B.

Here, FIG. 7C is an explanatory diagram in which the image of the object B formed on a specific portion of a retina of the observer viewing the image (object B) is located at a position relative to the specific portion. As described above, the viewing point of the observer is moved to right at the almost constant speed, while the object B is discretely moved to right every frame period Pf. Accordingly, the position of the object B recognized by the observer in the second period Pf2 is relatively deviated to right from the position of the object B recognized in the first period Pf1. Accordingly, the outline of the object B substantially recognized by the observer is varied in the range Δ in the frame period Pf. As a result, the outline of the object B is recognized unclear. In other words, since the gray scale of the object B and the gray scale of the background are averaged (integrated) over the frame period Pf, it can be explained that the outline is recognized unclear.

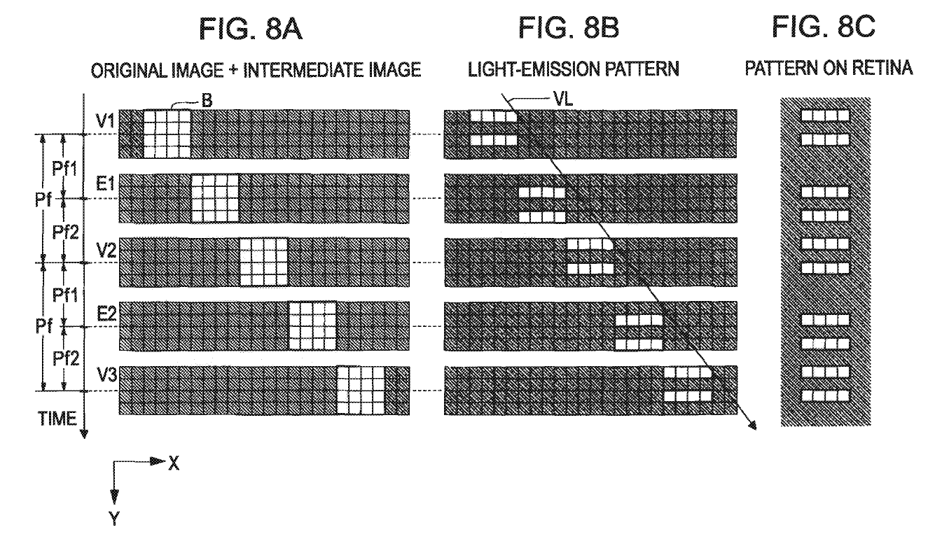

On the contrary, in the first embodiment, as shown in FIG. 8A, the original images V1, V2, and V3 are displayed in the first period Pf1 of the frame period Pf. On the other hand, the intermediate images E1 and E2 generated from the successive original images are displayed in the second periods Pf2 of the frame periods Pf. FIG. 8B is a diagram illustrating patterns of the images substantially displayed on the display panel 30 in the first period Pf1 and the second period Pf2 of each frame period Pf. As shown in the figure, the object B displayed in the second period Pf2 is obtained by moving to right by 4 pixels the object B displayed in the first period Pf1 right before. That is, the object B recognized by the observer is moved to follow the movement of the viewing line indicated by the arrow VL in FIG. 8B in the first period Pf1 and the second period Pf2. Accordingly, as shown in FIG. 8C, the position of the object B recognized by the observer is not deviated. Here, it is assumed that the object B is moved in the horizontal direction, but the same operation and advantage can be obtained when the object B is moved in the vertical direction. As described above, according to the first embodiment, it is possible to effectively suppress the flickers and the image blurs.

### B: Second Embodiment

A second embodiment of the invention will be described below. In the second embodiment described below, the same elements as those of the first embodiment are denoted by the same reference numerals and description thereof will be properly omitted.

Such a configuration has been exemplified in the first embodiment that the pixel circuits 60 are partitioned into two groups of the odd-row group and the even-row group, the pixel circuits 60 in the odd-row group are allowed to emit light in the first period Pf1, and the pixel circuits 60 in the even-row group are allowed to emit light in the second period Pf2. However, the number of groups into which the display unit 32 is divided is not limited to it in the invention. In the second embodiment, it is exemplified that a plurality of pixel circuits 60 constituting a display unit 32 are partitioned into three groups.

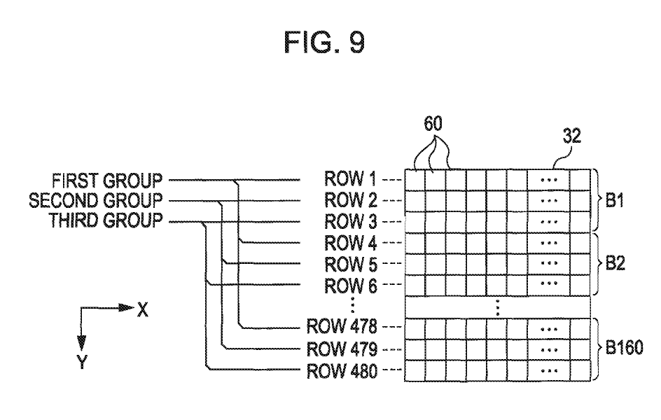

FIG. 9 is a diagram illustrating a partition method into groups according to the second embodiment. As shown in the figure, in the second embodiments the display unit 32 is partitioned into a plurality of unit areas B (B1 to B160) in a unit of three rows which are sequentially arranged in the Y direction. In each unit area B, the pixel circuits 60 in a first row (row 3k+1 as a whole of the display unit 32) constitute a first group, the pixel circuits 60 in a second row (row 3k+2 as a whole of the display unit 32) constitute a second group, and the pixel circuits 60 in a third row (row 3k+3 as a whole of the display unit 32) constitute a third group (where k is an integer satisfying 0≦k≦159). On the other hand, in the second embodiment, each frame period Pf (of which the time length is Tf) is divided into a first period Pf1, a second period Pf2, and a third period Pf3, each time length of which is “⅓×Tf.” A light-emission control circuit 38 allows the pixel circuits 60 of the first group to emit light in the first period Pf1, allows the pixel circuits 60 of the second group to emit light in the second period Pf2, and allows the pixel circuits 60 of the third group to emit light in the third period Pf3. Specific operations of the respective units according to the second embodiment are as follows.

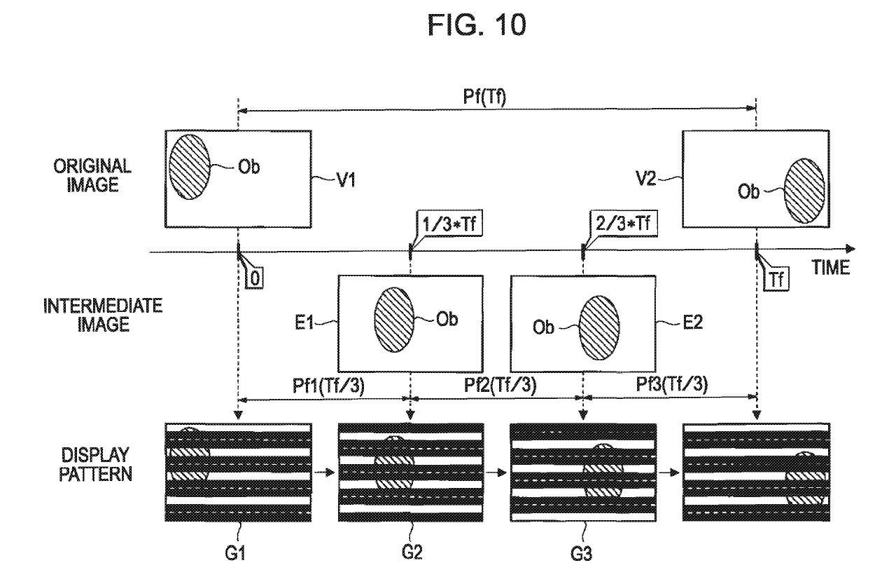

FIG. 10 is an explanatory diagram illustrating a detailed operation of an image processing unit 10 according to the second embodiment. As shown in the figure, the intermediate image generator 12 according to the second embodiment generates intermediate images E1 and E2 corresponding to the times (⅓×Tf and ⅔×Tf) for dividing into threes the frame period Pf from the time “0” to display the original image V1 to the time “Tf” to display the original image V2, on the basis of the first image data D1 of the successive original images V1 and V2, and stores the generated intermediate image data in the frame memory 20. For example, the motion vectors extracted from the original image V1 and the original image V2 are multiplied by a coefficient “⅓” corresponding to the time “⅓×Tf” and the intermediate image E1 is generated from the result of the multiplication. The intermediate image E2 is generated from the result of multiplication of the motion vector by “⅔×Tf.” In this way, by changing the ratio multiplied by the motion vector, the intermediate images E1 and E2 are generated. It is necessary to calculate the motion vector for each intermediate image. Accordingly, even when a plurality of intermediate images is generated, the amount of calculation is not greatly increased in comparison with the first embodiment.

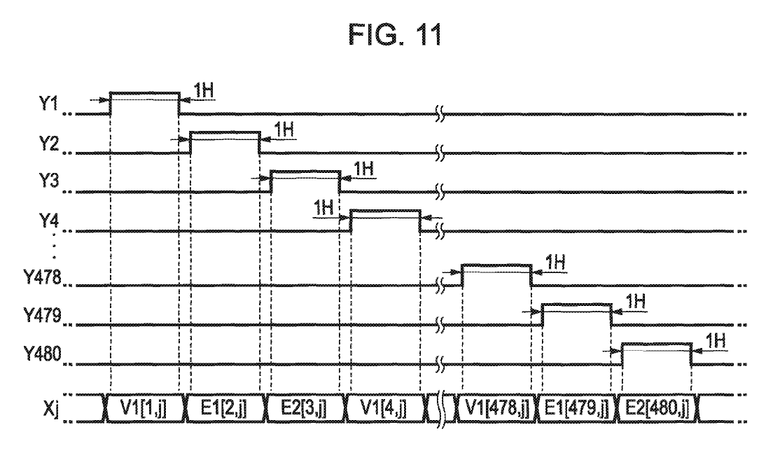

The image corresponding to the second image data D2 output from the controller 14 is in such a pattern that the pixels in the first row of the blocks obtained by partitioning the original image V1 in a unit of three rows, the pixels in the second row of the blocks obtained by partitioning the intermediate image E1 in a unit of three rows, and the pixels in the third row of the blocks obtained by partitioning the intermediate image E2 in a unit of three rows are sequentially arranged. Accordingly, as shown in FIG. 11, in the horizontal scanning period where the scanning signals Y (Y1, Y4, Y7, . . . , Y478) in row 2k+1 are changed to the high level, the data signals Xj having levels corresponding to the pixels V1(1,j), V1(4,j), . . . , V1(478,j) in row 3k+1 of the original image V1 are supplied to the pixel circuits 60 in row 3k+1 belonging to the first group. Similarly, the data signals Xj having levels corresponding to the pixels E1(2,j), E1(5,j), . . . , E1(479,j) in row 3k+2 of the intermediate image E1 are supplied to the pixel circuits 60 in row 3k+2 belonging to the second group, and the data signals Xj having levels corresponding to the pixels E2(3,j), E2(6,j), . . . , E2(480,j) in row 3k+3 of the intermediate image E2 are supplied to the pixel circuits 60 in row 3k+3 belonging to the third group.

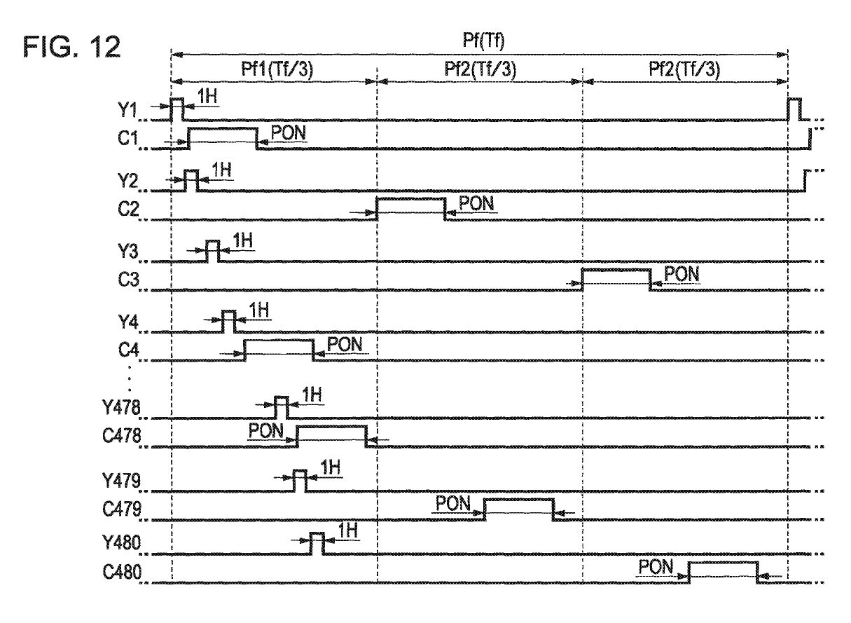

FIG. 12 is a timing diagram illustrating operations of the selection circuit 34 and the light-emitting control circuit 38. As shown in the figure, the selection circuit 34 sequentially selects the 480 scanning lines 51 in the periods (first period Pf1, second period Pf2, and third period Pf 3) obtained by dividing the frame period Pf into three periods. On the other hand, the light-emission control circuit 38 allows the light-emitting elements 63 belonging to the first group (the light-emitting elements 63 in the first row of the respective unit area B) to sequentially emit light in the first period Pf1 by sequentially changing the light-emission control signals C3k+1 supplied to the light-emission control lines 53 in row 3k+1 to the high level. In addition, the light-emission control circuit 38 allows the light-emitting elements 63 belonging to the second group to sequentially emit light in the second period Pf2 by sequentially changing the light-emission control signals C3k+2 corresponding to row 3k+2 to the high level. In addition, the light-emission control circuit 38 allows the light-emitting elements 63 belonging to the third group to sequentially emit light in the third period Pf3 by sequentially changing the light-emission control signals C3k+3 corresponding to row 3k+3 to the high level.

As a result of the above-mentioned operation, as indicated by the image G1 in FIG. 10, the original image V1 is displayed by the light emission of the light-emitting elements 63 belonging to the first group and the light-emitting elements belonging to the second group and the third group are extinguished, in the first period Pf1 from the time “0” to the time “⅓×Tf” shown in the figure. Similarly, the intermediate image E1 is displayed by the light emission of only the light-emitting elements 63 belonging to the second group in the second period Pf2 from the time “⅓×Tf” to the time “⅔×Tf” (image G2), and the intermediate image E2 is displayed by the light emission of only the light-emitting elements 63 belonging to the third group in the third period Pf3 from the time “⅔×Tf” to the time “Tf” (image G3). The above-mentioned operation is repeated every frame period Pf.

As described above, in the second embodiment, the light-emitting elements 63 of a unit area B repeat the light emission and extinction with a cycle of time obtained by dividing the frame period Pf into three periods Accordingly, the flickers recognized by the observer can be controlled to the level substantially equal to that of the case that the frame rate of the display panel 30 is enhanced to three times. In addition, since the time length of the light emission period when the image recognized by the observer is shortened, it is possible to better control the image blurs in comparison with the first embodiment.

### C: Third Embodiment

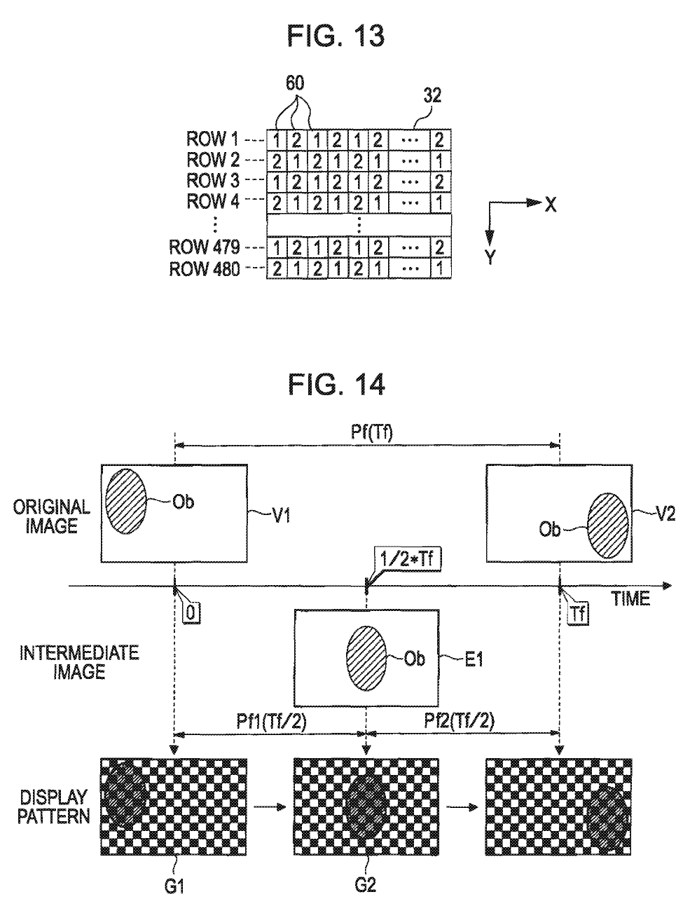

A third embodiment of the invention will be described below. Although it has been exemplified in the first embodiment and the second embodiment that a plurality of pixel circuits 60 is partitioned into groups in a unit of row, the partitioning method into groups is not limited to it. FIG. 13 is a diagram illustrating a partitioning method into groups according to the third embodiment. In the figure, squares marked by “1” indicates pixel circuits 60 belonging to a first group and squares marked by “2”, indicates pixel circuits 60 belonging to a second group.

As shown in FIG. 13, in the third embodiment, a plurality of pixel circuits 60 is partitioned into the first group and the second group so that the pixel circuits 60 of the first group and the pixel circuits 60 of the second group are adjacent to each other in both the X axis direction and the Y axis direction (that is, so that the pixel circuits 60 of the second group are adjacent to a pixel circuit 60 of the first group in the X axis direction and the Y axis direction. Accordingly, when the pixel circuits 60 of one of the first group and the second group are allowed to emit light and the pixel circuits 60 of the other are extinguished a checker shape in which white pixels and black pixels are arranged different in the X axis direction and the Y axis direction is displayed on the display unit 32.

FIG. 14 is an explanatory diagram illustrating operations of the third embodiment. As shown in the figure, in the third embodiment, the intermediate image E1 to be displayed at the time “½×Tf” corresponding to a center point between the start point (time “0”) and the end point (time “Tf”) of the frame period Pf is generated by the intermediate image generator 12. The controller 14 generates the second image data D2 corresponding to the image that the pixels in the odd columns of the odd rows and the pixels in the odd columns of the even rows of the original image V1 and the pixels in the even columns of the odd rows and the pixels in the odd columns of the even rows of the intermediate image E1, and outputs the second image data to the data-line driving circuit 36. The original image V1 is displayed by the light emission of the pixel circuits 60 of the first group in the first period Pf1 (image G1 in FIG. 14) and the intermediate image E1 is displayed by the light emission of the pixel circuits 60 of the second group in the second period Pf2 (image F2 in FIG. 14).

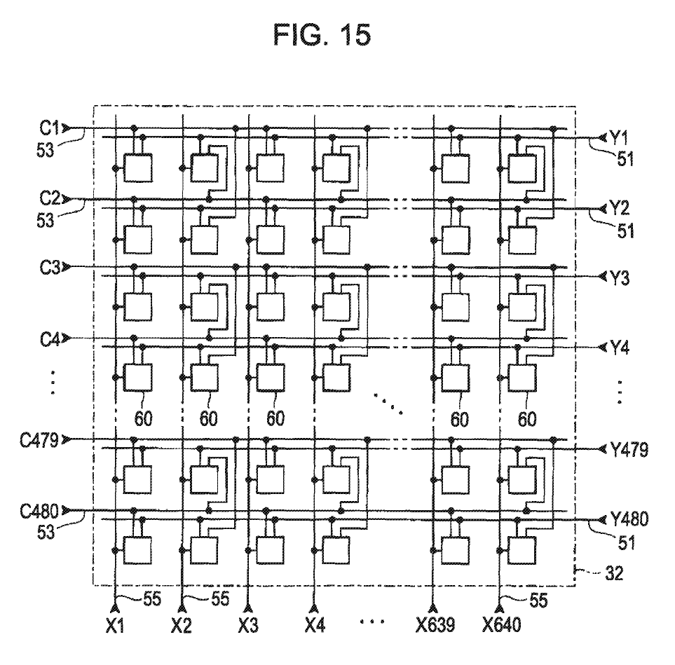

On the other hand, in order to light and extinguish the light-emitting elements 63 of the pixel circuits 60 in the above-mentioned pattern, the display unit 32 according to the third embodiment has a configuration shown in FIG. 15. Now, row 2k+1 and row 2k+2 adjacent to each other in the Y direction is paid attention to. As shown in the figure, the pixel circuits 60 in the odd columns among the 640 pixel circuits 60 belonging to row 2k+1 are connected to the light-emission control line 53 of row 2k+1, and the pixel circuits 60 in the even columns of the same row are connected to the light-emission control line 53 of row 2k+2. In addition, the pixel circuits 60 in the odd columns of row 2k+1 are connected to the light-emission control line 53 of row 2k+2, and the pixel circuits 60 in the even columns of the same row are connected to the light-emission control line 53 of row 2k+1. For example, the pixel circuits 60 in the odd columns of the first row and the pixel circuits 60 in the even columns of the second row are connected to the light-emission control line 53 of the first row supplied with the light-emission control signal C1, and the pixel circuits 60 in the even columns of the first row and the pixel circuits 60 in the odd columns of the second row are connected to the light-emission control line 53 of the second row supplied with the light-emission control signal C2.

In the third embodiment, the waveforms of the light-emission control signals C (C1 to C480) are equal to those of the first embodiment (FIG. 2). However, in the third embodiment, the pixel circuits 60 are connected to the light-emission control lines 53 as shown in FIG. 15. Accordingly, for example, when the light-emission control signal C1 supplied to the light-emission control line 53 of the first row is changed to the high level in the first period Pf1, as indicated by the image C1 in FIG. 14, the light-emitting elements 63 in the odd columns of the first row and the light-emitting elements 63 in the even columns of the second row simultaneously emit light. On the other hand, when the light-emission control signal C2 supplied to the light-emission control line 53 of the second row is changed to the high level in the second period Pf2, as indicated by the image G2 in FIG. 14, the light-emitting elements 63 in the even columns of the first row and the light-emitting elements 63 in the odd columns of the second row simultaneously emit light.

According to the third embodiment, it is possible to obtain the same advantages as the first embodiment. Furthermore, in the third embodiment, since the pixel circuits 60 of the first group and the pixel circuits 60 of the second group are distributed more discretely than those of the first embodiment, it is possible to easily make the image quality all uniform over the display unit 32. The partitioning method into groups in the X axis direction and the Y axis direction is not limited to the above-mentioned examples. For example, the following aspects may be employed.

C-1: First Aspect

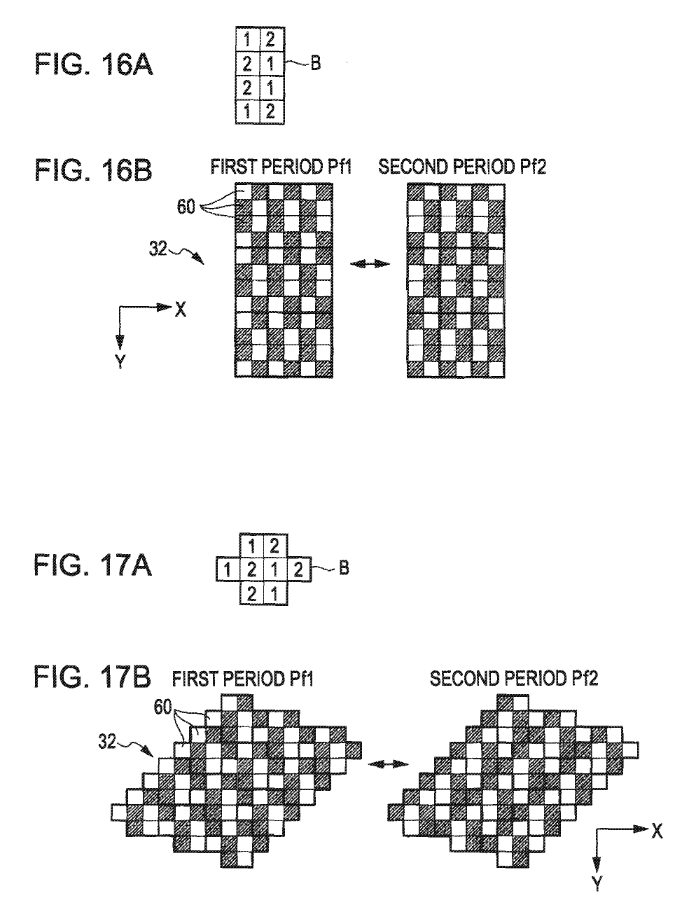

FIG. 16B is a diagram illustrating a lighting and extinction pattern of the light-emitting elements 63 in the first period Pf1 and the second period Pf2. In the figure, the hatched squares indicate the pixel circuits 60 under extinction and the non-hatched squares indicate the pixel circuits 60 under lighting. In the third embodiment, as shown in FIG. 16A, a plurality of pixel circuits 60 constituting the display unit 32 are partitioned into 4 rows×2 columns unit areas. In FIG. 16A, the squares marked by “1” indicate the pixel circuits 60 belonging to the first group and the squares marked by “2” indicate the pixel circuits 60 belonging to the second group.

As shown in FIG. 16B, the four pixel circuits 60 (rows 1 and 4 of the first column and rows 2 and 3 of the second column) belonging to the first group of one unit area B emit light in the first period Pf1 of each frame period Pf. On the other hand, as shown in FIG. 16B, the four pixel circuits 60 belonging to the second group of one unit area B emit light in the second period Pf2 of each frame period Pf. Similarly to the example shown in FIG. 15, the light emission in such a pattern is embodied by properly selecting the connection pattern between the light-emission control lines 53 and the pixel circuits 60.

C-2: Second Aspect

The shape of the unit area B is not limited to the quadrangle. For example, as shown in FIG. 17A, the unit area B according to the second pattern has a concave dodecagon shape including four pixel circuits 60 arranged in the X direction, two pixel circuits 60 adjacent to the positive side in the Y direction of the two intermediate pixel circuits among the four pixel circuits 60, and two pixel circuits 60 adjacent to the negative side in the Y direction of the two intermediate pixel circuits. In the configuration that the display unit 32 is partitioned into the unit areas B having the shape shown in FIG. 17A, the lighting and extinction pattern of the light-emitting elements 63 in the first period Pf1 and the second period Pf2 is as shown in FIG. 17B.

C-3: Third Aspect

Although it has been exemplified in the first and second aspect that the display unit 32 is partitioned into two groups, the same configuration can be employed in an aspect in which the display unit 32 is partitioned into three groups (or four or more groups) as described in the second embodiment.

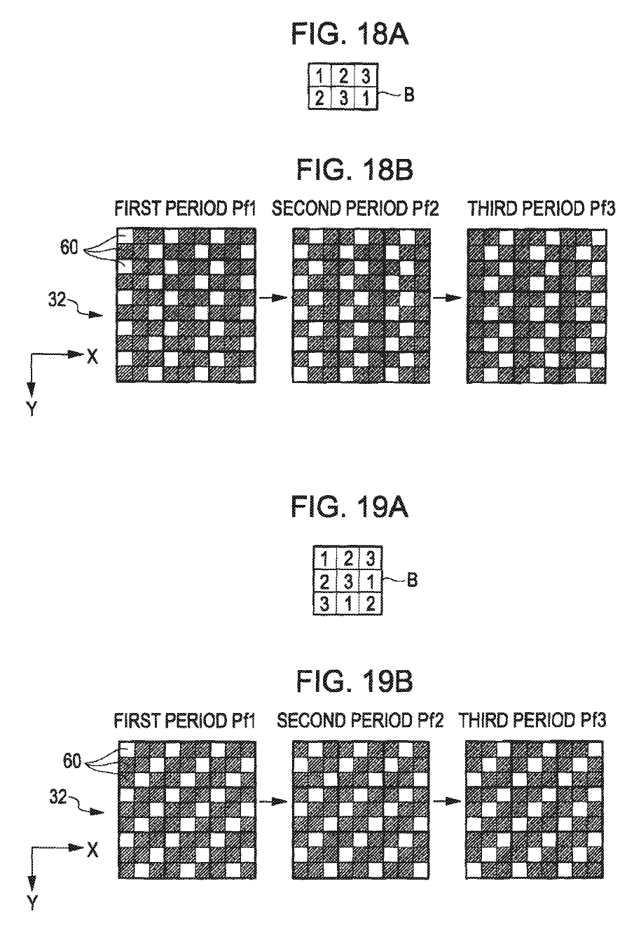

For example, as shown in FIG. 18A, the display unit 32 may be partitioned into unit areas B of 2 rows×3 columns and each unit area B may be partitioned into individual groups by combination of two pixel circuits 60 selected so as not to overlap with each other among the six pixel circuits 00 belonging to the unit area B. That is, in the example shown in FIG. 18A, the two pixel circuits 60 in column 1 of row 1 and column 3 of row 2 among the six pixel circuits 60 belonging to each unit area B constitute a first group, the two pixel circuits 60 in column 2 of row 1 and column 1 of row 2 constitute a second group, and the two pixel circuits 60 in column 3 of row 1 and column 2 of row 2 constitute a third group. As shown in FIG. 18B, the light-emitting elements 63 of the pixel circuits 60 belonging to the first group emit light in the first period Pf1 of each frame period Pf, the light-emitting elements 63 of the second group emit light in the second period Pf2, and the light-emitting elements 63 of the third group emit light in the third period Pf3.

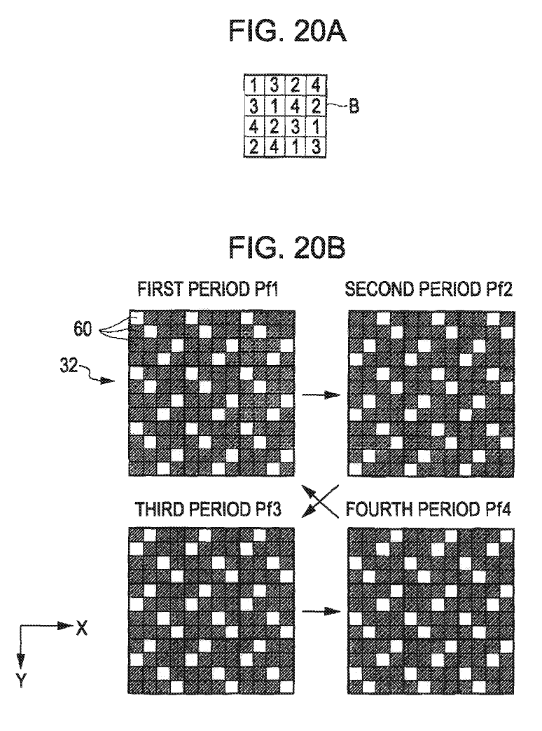

In the third aspect, the type (shape or size) of the unit area B can be changed arbitrarily. For example, when the display unit 32 is partitioned into unit areas B shown in FIG. 19A, the light emission pattern of the light-emitting elements 63 is as shown in FIG. 19B. A plurality of pixel circuits 60 may be partitioned into four groups by dividing the display unit 32 into the unit areas B shown in FIG. 20A. In this aspect, as shown in FIG. 20A, the light-emitting elements 63 of the groups emit light in the periods Pf1, Pf2, Pf3, and Pf4 obtained by dividing one frame period Pf into four periods.

A variety of light emission patterns as described above can be employed. In the real design, any one pattern may be employed to correspond to the configuration (for example, arrangement of the pixel circuits 60, the scanning lines 51, or the data lines 55) of the display panel 30 so that the simplicity of the layout of the light-emission control lines 53 or the security of connection to the pixel circuits 60 are guaranteed. Alternatively, any one pattern may be employed on the basis of the degree of flickers occurring in the respective patterns or the result of estimating the image quality. In the third embodiment, since a variety of light emission patterns is employed in comparison with the first embodiment or the second embodiment in which the pixel circuits 60 are partitioned in a unit of row, it is possible to improve the degree of freedom in design of the light-emitting device 100.

### D: Fourth Embodiment

In the third embodiment illustrated in FIG. 15, it is necessary to allow lines for connecting the pixel circuits 60 to the scanning lines 51 or the light-emission control lines 53 to intersect the scanning lines 51 or the light-emission control lines 53 at many places. For example, in FIG. 15, the line for connecting the pixel circuits 60 in the even columns of row 2 (for example, column 2 of row 2) to the light-emission control line 53 of row 1 intersect total three lines of the scanning line 51 of row 1, the scanning line 51 of row 2, and the light-emission control line 53 of row 2. In the configuration in which the lines intersect each other at many places, capacitance is parasitic between the lines, thereby causing a problem that the signal waveform is blunted or a problem that the aperture ratio of the pixel circuit 60 (a ratio of an area where light is irradiated from a light-emitting element 63 to an area occupied by the pixel circuit 60) is reduced. The fourth embodiment is designed to solve the above-mentioned problems by simplifying the pattern of the lines.

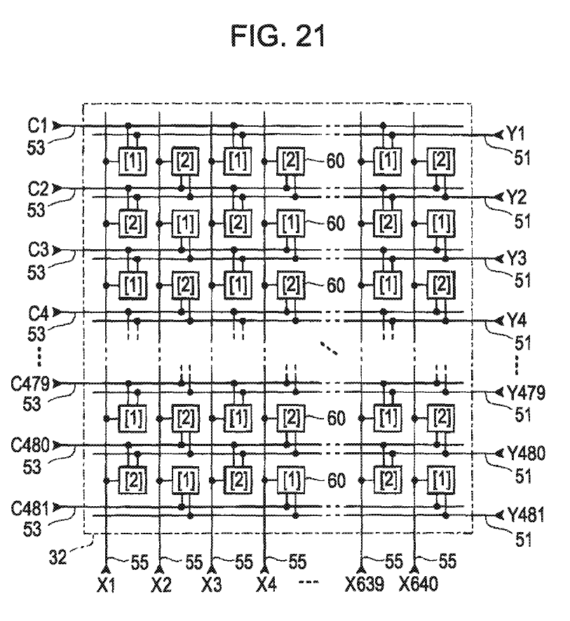

FIG. 21 is a block diagram illustrating an electrical configuration of the display unit 32 according to the fourth embodiment. As shown in the figure, 481 line pairs, each of which includes a scanning line 51 and a light-emission control line 53 extending in the X direction, are arranged in the Y direction on the display unit 32. The 640 pixel circuits 60 are arranged in the x direction in the gaps (480 rows) between the line pairs successive in the Y direction. As shown in FIG. 21, the pixel circuits 60 in the odd columns among the 640 pixel circuits 60 in row i are connected to the line pair of row i adjacent to the negative side in the Y direction thereof, and the pixel circuits 60 in the even columns thereof are connected to the line pair of row i+1 (the scanning line 51 and the light-emission control line 53) adjacent to the positive side in the Y direction thereof.

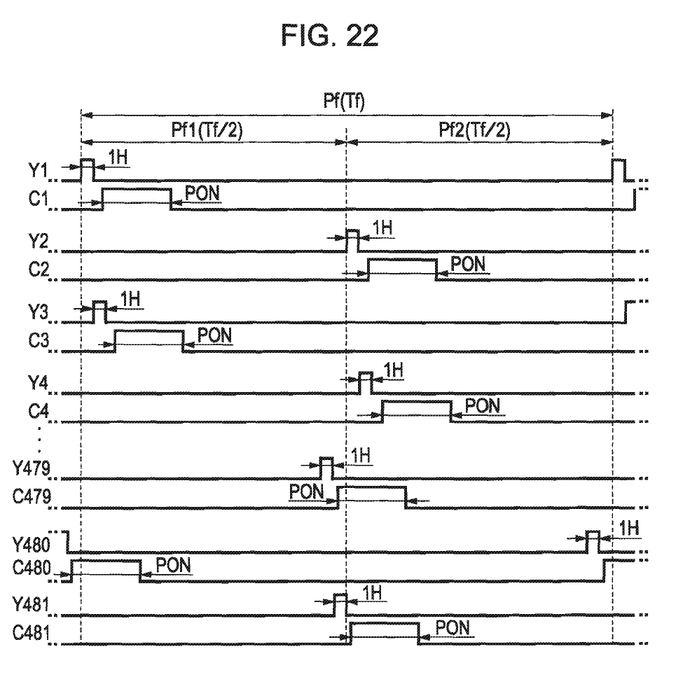

FIG. 22 is a timing diagram illustrating operations of the selection circuit 34 and the light-emission control circuit 38. As shown in the figure, the selection circuit 34 according to the fourth embodiment sequentially changes the scanning signals Y2k+1 (Y1, Y3, . . . , Y479, and Y481) supplied to the scanning lines 51 in the odd rows to the high level every horizontal scanning period in the first period Pf1 which is a first half of each frame period Pf. The selection circuit 34 sequentially changes the scanning signals Y2k+2 (Y2, Y4, . . . , and Y480) in the even rows to the high level every horizontal scanning period in the second period Pf2 which is a second half of each frame period Pf. On the other hand, the light-emitting control circuit 38 maintains the light-emission control signal Ci supplied to the light-emission control line 53 of row i at the high level for the light emission period Pon right after the scanning signal Yi is changed to the low level.

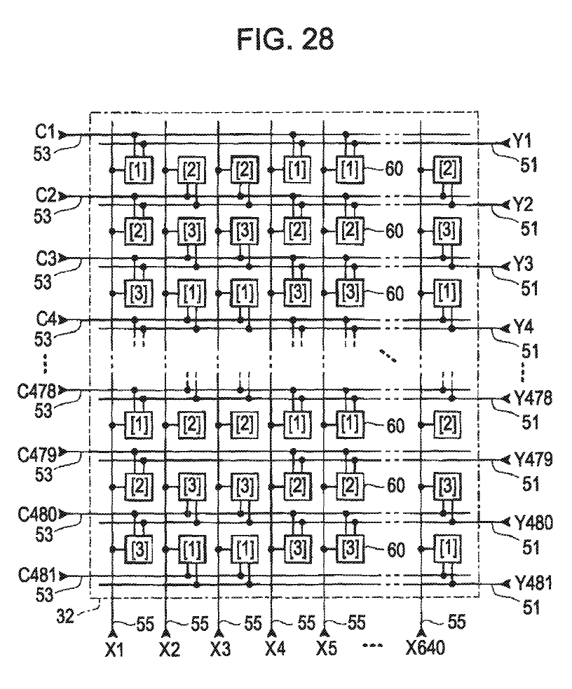

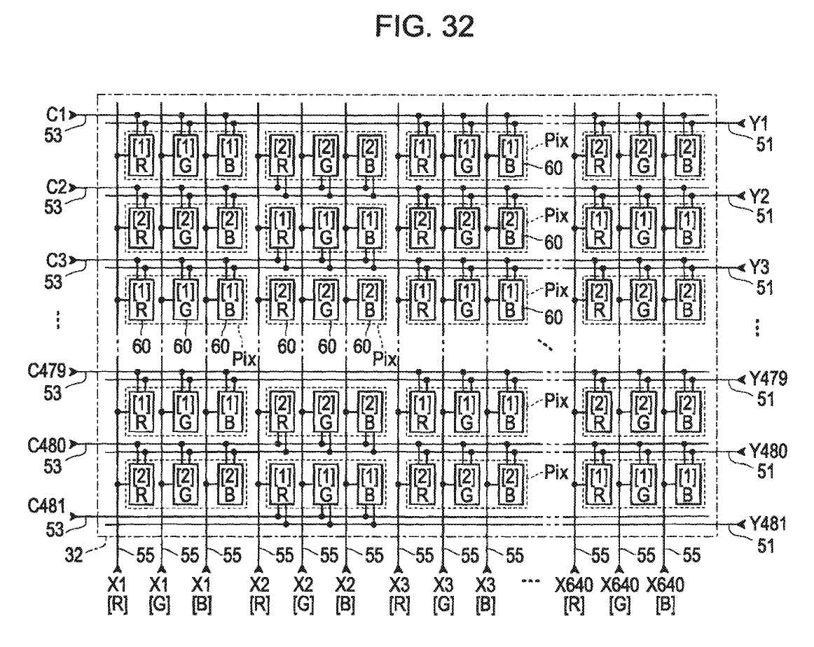

As can be seen from the configuration shown in FIG. 21, when the light-emission control signals C2k+1 of the odd rows are changed to the high level every horizontal scanning period of the first period P1, the light-emitting elements 63 of the pixel circuits 60 (first group) in the odd columns of the odd rows and the even columns of the even rows emit light. In addition, when the light-emission control signals C2k+2 of the even rows are changed to the high level every horizontal scanning period of the second period Pf2, the light-emitting elements 63 of the pixel circuits 60 (second group) in the even columns of the odd rows and the odd columns of the even rows emit light. That is, in the fourth embodiment, a plurality of pixel circuits 60 is partitioned into a first group and a second group in the same manner as the third embodiment (FIG. 13). In FIG. 21, reference numeral 1 denoting the pixel circuits 60 of the first group and reference numeral 2 denoting the pixel circuits 60 of the second group are marked in the squares corresponding to the pixel circuits 60 (the same is true of FIGS. 28 and 32).

The data-line driving circuit 36 outputs the data signals Xj corresponding to the pixels (first group in the odd columns of the odd rows and the even columns of the even rows of the original image V1 every horizontal scanning period of the first period Pf1. The data-line driving circuit 36 outputs the data signals Xj corresponding to the pixels (second group) in the even columns of the odd rows and the odd columns of the even rows of the intermediate image E1 every horizontal scanning period of the second period Pf2. As a result, similarly to the third embodiment shown in FIG. 14, the original image V1 is displayed by the light emission of the light-emitting elements 63 of the first group and the intermediate image E1 is displayed by the light emission of the light-emitting elements 63 of the second group.

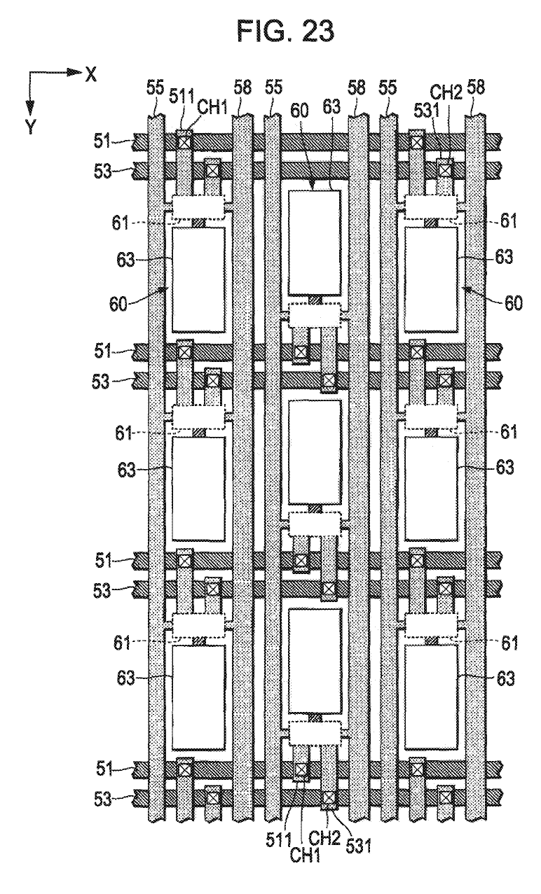

FIG. 23 is a plan view illustrating a specific structure of the lines and the pixel circuits 60. The scanning lines 51 and the light-emission control lines 53 are formed on the surface of a substrate (not shown) out of a conductive material such as aluminum. In the fourth embodiment, the scanning lines 51 and the light-emission control lines 53 are simultaneously formed by the same process of selectively removing the conductive layer formed on the substrate (that is, is formed in the same layer). The surface of the substrate on which the scanning lines 51 and the light-emission control lines 53 is covered with an insulating layer (not shown). As shown in FIG. 23, the data lines 55, the power supply lines 58, and wiring portions 511 and 531 are formed in the same layer on the insulating layer out of a conductive material such as aluminum. According to the configuration that a plurality of elements are formed in the same layer described above, it is possible to obtain the simplification of manufacturing processes and the saving of manufacturing cost in comparison with the configuration that the plurality of elements is formed in different layers.

The power supply lines 58 for supplying high potential Vdd from a power source extend in the Y direction with a gap from the data lines 55 as shown in FIG. 23. The pixel circuits 60 are disposed in areas surround with the line pairs adjacent to each other in the Y direction and the data lines 55 and the power supply lines 58 adjacent to each other in the X direction, respectively, as seen in a direction perpendicular to the substrate. Each pixel circuit 60 includes a driving portion 61 and a light-emitting element 63 connected to each other. The driving portion 61 is a circuit (a portion other than the light-emitting element 63 in the pixel circuit 60 shown in FIG. 3) for driving the light-emitting element 63 and is electrically connected to the corresponding data line 55 and the corresponding power supply line 58 adjacent to each other in the X direction.

The wiring portion 511 is a line for electrically connecting the driving portion 61 to the scanning line 51. The wiring portion 511 extends in the Y direction from the driving portion 61 (the gate electrode of the switching transistor Tsw and the gate electrode of the selection transistor Tsel) and is electrically connected to the corresponding scanning line 51 through a contact hole CH1 formed through the insulating layer. On the other hand, the wiring portion 531 extends in the Y direction from the driving portion 61 (the gate electrode of the light-emission control transistor Tel) and is electrically connected to the corresponding light-emission control line 53 through a contact hole CH2 formed through the insulating layer.

As shown in FIG. 23, the driving portion 61 of each pixel circuit 60 is disposed between the corresponding scanning line 51 and light-emission control line 53, which are connection destinations of the pixel circuit 60, and the light-emitting element 63 of the pixel circuit 60. Accordingly, as shown in FIG. 23, the wiring portions 511 and the wiring portions 531 of the pixel circuits 60 in the odd columns (for example, the left column and the right column in FIG. 23) extend in the negative Y direction from the driving portions 61 to overlap with the scanning lines 51 or the light-emission control lines 53. In addition, the wiring portions 511 and the wiring portions 531 of the pixel circuits 60 in the even columns (for example, the center column in FIG. 23) extend in the positive Y direction from the driving portions 61 to overlap with the scanning lines 51 or the light-emission control lines 53.

As described above, the pixel circuits 60 according to the fourth embodiment are connected to the line pairs (the scanning line 51 and the light-emission control line 53) adjacent to one of the positive side and the negative side in the Y direction. According to this configuration, since the shapes of the wiring portions 511 and the wiring portions 531 are simplified, it is possible to prevent the short-circuit or opening of the lines and to suppress the decrease in aperture ratio of the pixel circuits 60, while maintaining the degree of freedom in layout of the lines. In the fourth embodiment, it is not necessary to allow the wiring portions 511 and 531 to intersect other elements (the scanning lines 51 or the light-emission control lines 53) several times. According to this configuration, it is possible to reduce the capacitance (parasitic capacitance between the scanning lines 51 or the light-emission control lines 53 and the wiring portions 511 or the wiring portions 531) parasitic on the lines in comparison with the configuration shown in FIG. 15. Therefore, it is possible to suppress the blunt of the waveforms of the signals such as the scanning signals Yi or the light-emission control signals Ci and to operate the transistors of the pixel circuits 60 at a high speed.

In the above-mentioned embodiment, it has been exemplified that the 481 line pairs greater than the number of rows of the pixel circuits 60 are formed in order to drive the pixel circuits 60 of the first group belonging to row 480. However, when the pixel circuits 60 of the first group belonging to row 480 are not visible in the display of an image (for example, when the pixel circuits are hidden under the frame) or when the pixel circuits 60 of the first group belonging to row 480 are not used for the display of an image (for example, when the number of rows of an image specified by the second image data D2 is smaller than the number of rows of the pixel circuits 60 in the display unit 32), the line pair of row 481 can be omitted.

In the fourth embodiment, the method of partitioning the pixel circuits 60 into groups is arbitrary. For example, the following aspects may be employed.

D-1: First Aspect

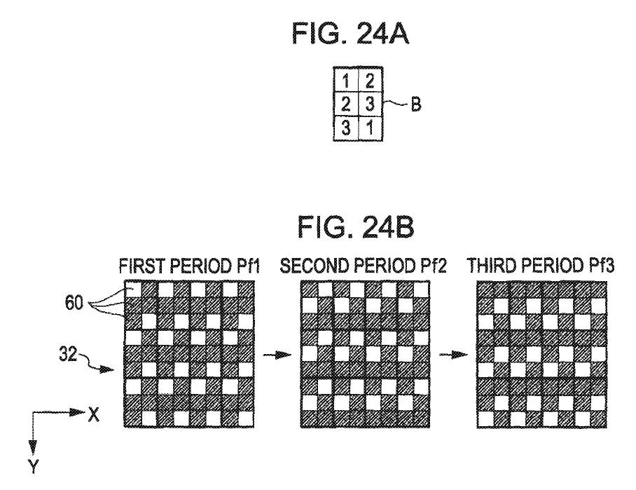

As shown in FIG. 24A, the display unit 32 may be partitioned into three (or four or more) groups. In the figure, the display unit 32 is partitioned into unit areas B of 3 rows×2 columns without a gap. Among six pixel circuits 60 belonging to each unit area B, two pixel circuits 60 in column 1 of row 1 and column 2 of row 3 constitute a first group (denoted by reference numeral 1 in FIG. 24A), two pixel circuits 60 in column 2 of row 1 and column 1 of row 2 constitute a second group (denoted by reference numeral 2 in FIG. 24A), and two pixel circuits 60 in column 2 of row 2 and column 1 of row 3 constitute a third group (denoted by reference numeral 3 in FIG. 24A).

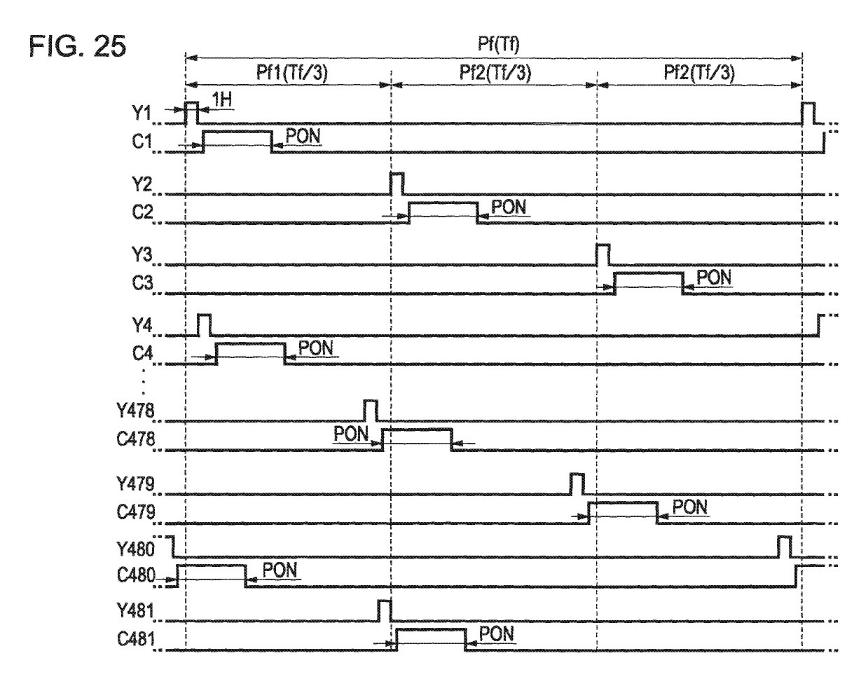

The partitioning into groups described above is embodied by operating the selection circuit 34 and the light-emission control circuit 38 in the configuration shown in FIGS. 21 and 23 in the same manner as shown in FIG. 25. As shown in FIG. 25, in this aspect, one frame period Pf is divided into three periods Pf1, Pf2, and Pf3. In the first period Pf1, the scanning signals Y3k+1 (Y1, Y4, . . . , Y478, and Y481) are sequentially changed to the high level every horizontal scanning period. Similarly, in the second period Pf2, the scanning signals Y3k+2 (Y2, Y5, . . . , and Y479) are sequentially changed to the high level and in the third period Pf3, the scanning signals Y3k+3 (Y3, Y6, . . . , and Y480) are sequentially changed to the high level. In addition, the light-emission control signals Ci are maintained at the high level for the light emission period Pon right after the scanning signals Yi is changed to the low level.

By generating the signals in the same manner as shown in FIG. 25 on the basis of the configuration shown in FIGS. 21 and 23, as shown in FIG. 24B, the light-emitting elements 63 of the first group emit light in the first period Pf1, the light-emitting elements 63 of the second group emit light in the second period Pf2, and the light-emitting elements 63 of the third group emit light in the third period Pf3. On the other hand, in the horizontal scanning period when the pixel circuits 60 of the first group are selected in the first period Pf1, the data signals Xj corresponding to the original image V1 are supplied to the corresponding pixel circuits 60. Similarly, the data signals Xj corresponding to the intermediate image E1 are supplied to the pixel circuits 60 of the second group in the second period Pf2, and the data signals Xj corresponding to the intermediate image E2 are supplied to the pixel circuits 60 of the third group in the third period Pf3.

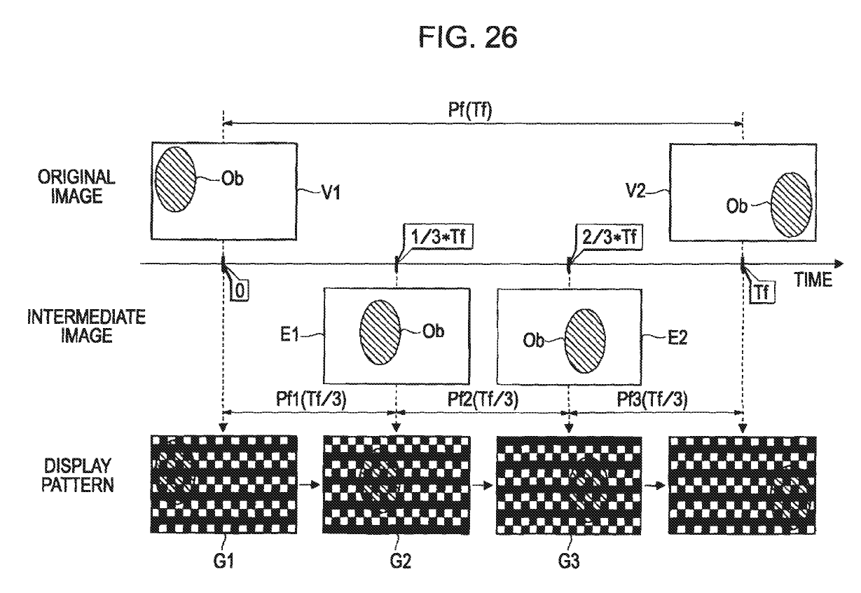

As a result, as shown in FIG. 26, the original image V1 is displayed by the light-emitting elements 63 of the first group in the first period Pf1 (image G1), the intermediate image E1 is displayed by the light-emitting elements 63 of the second group in the second period Pf2 (image G2), and the intermediate image E2 is displayed by the light-emitting elements 63 of the third group in the third period Pf3 (image G3). That is, according to the first aspect, it is possible to simplify the shapes of the wiring portions 511 or the wiring portions 531 in the same manner as shown in FIG. 23 and to obtain the same advantages as the second embodiment.

D-2: Second Aspect

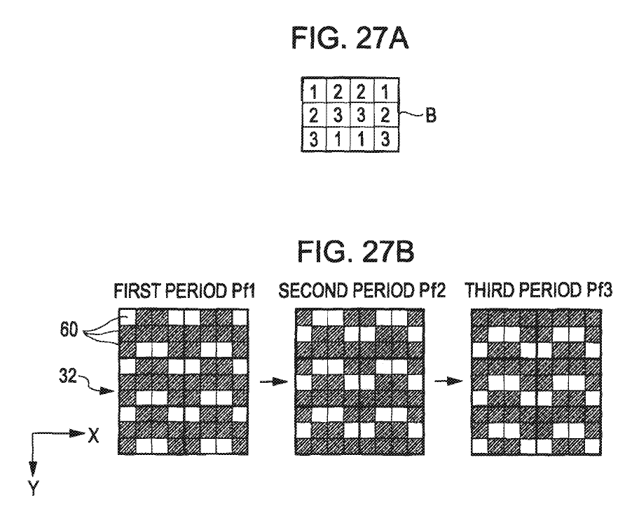

In the fourth embodiment, as shown in FIG. 27A, the display unit 32 is partitioned into unit areas B of 3 rows×4 columns. Twelve pixel circuits 60 belonging to each unit area B are partitioned into three groups (reference numerals 1 to 3 in FIG. 27A) by combination of four pixel circuits 60 selected so as not to overlap with each other.

FIG. 28 is a block diagram illustrating an electrical configuration of the display unit 32 according to the second aspect. As shown in the figure, the pixel circuits 60 in row i are connected to one of the line pair of row i (the scanning line 51 and the light-emission control line 53) and the line pair of row i+1. More specifically, the pixel circuits 60 of the first group are connected to the line pair of row 3k+1, the pixel circuits 60 of the second group are connected to the line pair of row 3k+2, and the pixel circuits 60 of the third group are connected to the line pair of row 3k+3. In the above-mentioned configuration, the scanning signals Yi and the light-emission control signals Ci having the waveforms shown in FIG. 25 are supplied to the pixel circuits 60. According to the above-mentioned configuration, similarly to the first aspect, the original image V1 is displayed by the pixel circuits 60 of the first group, the intermediate image E1 is displayed by the pixel circuits 60 of the second group, and the intermediate image E2 is displayed by the pixel circuits 60 of the third group.

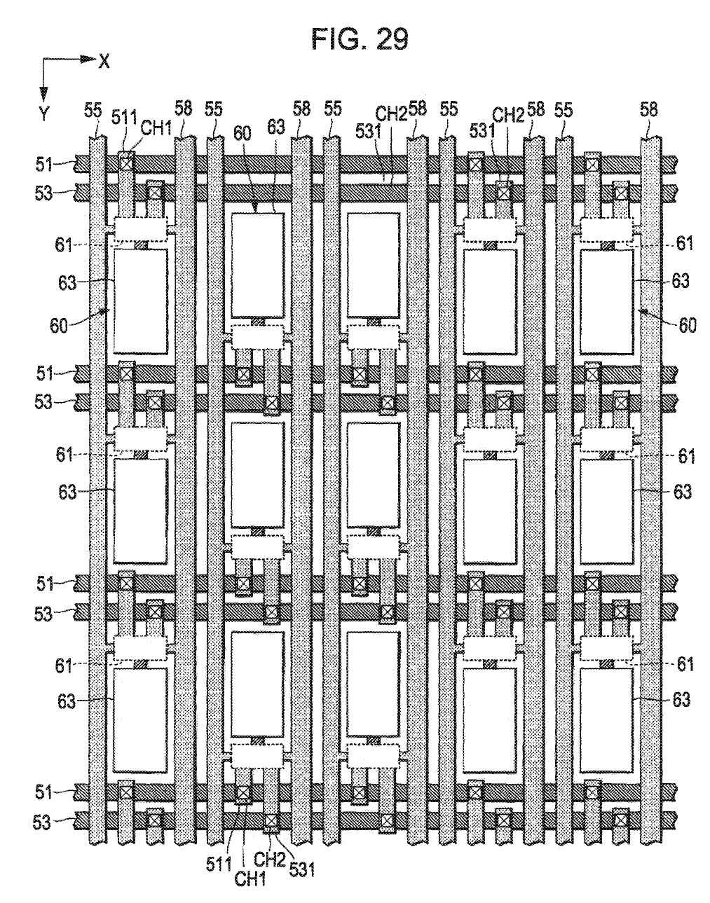

FIG. 29 is a plan view illustrating a specific configuration of the lines and the pixel circuits 60. As shown in the figure, the driving portion 61 of each pixel circuit 60 is connected to the line pair (the scanning line 51 and the light-emission control line 53) adjacent to one of the positive side and the negative side in the Y direction through the wiring portion 511 and the wiring portion 531 extending in the Y direction. Accordingly, according to the second aspect, similarly to the configuration shown in FIG. 23, it is possible to simplify the shapes of the wiring portions 511 or the wiring portions 531 and to suppress the capacitive coupling between the lines.

### E: Modified Examples

A variety of modifications may be made in the above-mentioned embodiments. Specific modified examples are described below. The following examples may be combined properly.

### (1) First Modified Example

In the first to third embodiments, it has been exemplified that the data signals X are supplied to all the pixel circuits 60 in the first period Pf1. In the configuration, since the data signals X are supplied to the pixel circuits 60 of the first group which emit light in the first period Pf1, the time length until the light-emitting elements 63 are driven is smaller than the time length until the light-emitting elements 63 are driven after the data signals X are supplied to the pixel circuits 60 of another group. On the other hand, current leakage may occur from the capacitive element C of each pixel circuit 60. The degree of leakage varies depending upon the time length after the electric charges of the current corresponding to the data signal X are accumulated in the capacitive element C. Accordingly, the electric charges accumulated in the capacitive element C at the time when the pixel circuits 63 substantially start emitting light can be distributed by groups. Then, the distribution of the electric charges is recognized as deviation in brightness of the light-emitting elements 63 by the observer.

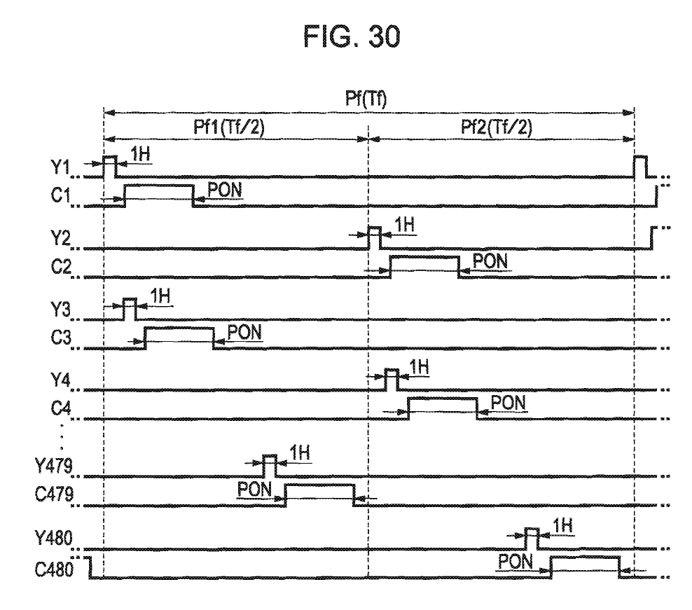

In order to such deviation in brightness of the light-emitting elements 63, for example, in the first embodiment, the data signals C may be supplied to the pixel circuits 60 emitting light in the first period Pf1, and the data signals X may be supplied to the pixel circuits 60 emitting light in the second period Pf2 right before the light emission in the second period Pf2. FIG. 30 is a timing diagram illustrating the operations of the selection circuit 34 and the light-emission control circuit 38 according to this aspect. As shown in the figure, the selection circuit 34 sequentially changes the scanning signals Y2k+1 supplied to the scanning lines 51 of the odd rows to the high level in the first period Pf1, and sequentially changes the scanning signals Y2k supplied to the scanning lines 51 of the even rows to the high level in the second period Pf2. On the other hand, the light-emission control circuit 38 maintains the light-emission control signal Ci supplied to the light-emission control line 53 of row i at the high level for the light-emission period Pon right after the scanning signal Yi is changed to the low level.

In the configuration according to the first modified example, since the time length from the time when the data signals X are supplied to the pixel circuits 60 to the time when the light-emitting elements 63 substantially emit light can be allowed to be substantially equal to each other in the pixel circuits 60 of the odd rows and the pixel circuits 60 of the even rows, the deviation in brightness of the light-emitting elements 63 due to the different in leakage from the capacitive elements C is suppressed. In addition, it has been exemplified that the first modified example is applied to the first embodiment. However, the same configuration can be applied to the second embodiment or the third embodiment. In addition, the same advantages can be obtained from the fourth embodiment (FIG. 22 or 25).

### (2) Second Modified Example

Although it has been exemplified in the above-mentioned embodiments that the second image data D2 of the image R1 obtained by synthesizing the original image V1 and the intermediate image E1 (E1 and E2 in the second embodiment) are output to the data-line driving circuit 36, both of the first image data D1 of the original image V1 and the image data of the intermediate image E1 may be supplied to the data-line driving circuit 36. In this case, the data-line driving circuit 36 generates, for example, the data signals X corresponding to the pixel circuits 60 in the odd rows from the first image data D1 of the original image V1 and outputs the generated data signals to the data lines 55. In addition, the data-line driving circuit 36 generates the data signals X corresponding to the pixel circuits 60 in the even rows from the image data of the intermediate image E1 and outputs the generated data signals to the data lines 55.

### (3) Third Modified Example

Although it has been exemplified in the above-mentioned embodiments that one frame image corresponding to all the pixels is generated into the intermediate image E1 (or E2), the intermediate image generated by the intermediate image generator 12 may be a part of the frame image. For example, in the first embodiment, since the intermediate image E is displayed by only the pixel circuits 60 in the even rows, the image including only the pixels in the even rows may be generated as the intermediate image E1 by the intermediate image generator 12.

### (4) Fourth Modified Example

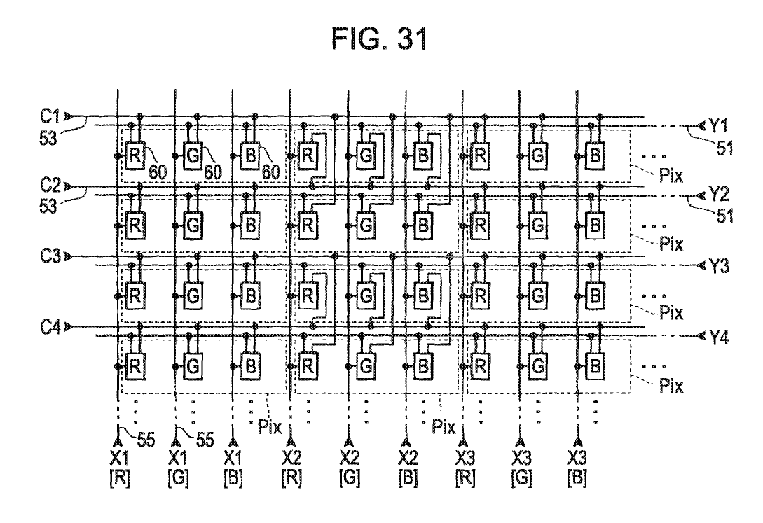

The above-mentioned embodiments can applied to a light-emitting device for displaying a color image by the use of arrangement of a plurality of pixel circuits 60 corresponding to different colors (for example, red, green, and blue). In such a kind of light-emitting device, the display unit 32 is partitioned into groups so that a plurality of pixel circuits 60 corresponding to one pixel (for example, three pixel circuits 60 corresponding to the colors of red, green, and blue, respectively) belong to a common group. Therefore, for example, when the third embodiment is applied to the light-emitting device for displaying a color image, as shown in FIG. 31, three pixel circuits 60 corresponding to the red (R), green (G), and blue (B) are connected to the common light-emission control line 53. That is, for example, the pixel circuits 60 of red, green, and blue corresponding to the respective pixels Piz (area surrounded by the dotted lines in FIG. 31) in the even columns belonging to row 2k+1 and the pixel circuits 60 of red, green, and blue corresponding to the pixels Pix in the odd columns belonging to row 2k+2 are connected in common to the light-emission control line 53 of row 2k+1. on the other hand, the pixel circuits 60 of three colors corresponding to the respective pixels Pix in the odd columns belonging to row 2k+1 and the pixel circuits 60 of three colors corresponding to the pixels Pix in the even columns belonging to row 2k+2 are connected in common to the light-emission control line 53 of row 2k+2. In this configuration, it is also possible to obtain the desired advantages of the invention by the same functions and operations as the third embodiment.

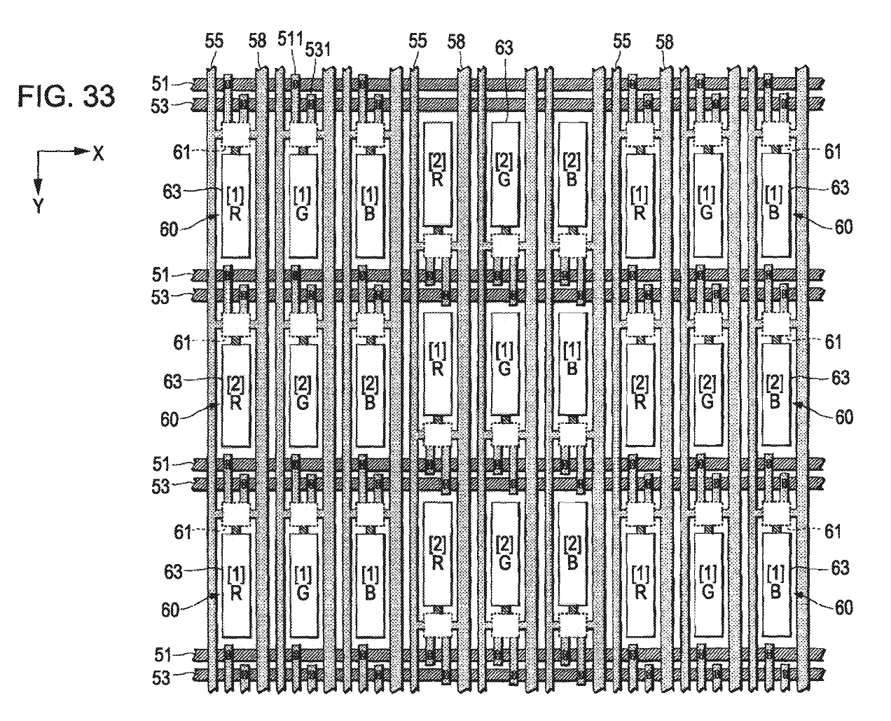

FIG. 32 is a block diagram illustrating a configuration of the display unit 32 when the fourth embodiment (FIGS. 21 to 23) is applied to the light-emitting device for displaying a color image. FIG. 33 is a plan view illustrating a layout of the elements in the display unit 32. As shown in FIGS. 32 and 33, three pixel circuits 60 constituting the respective pixels Pix of the first group in the odd rows (the upper and lower rows in FIG. 33) are connected in common to the line pair located on the negative side in the Y direction thereof, and three pixel circuits 60 constituting the respective pixels Pix of the second group are connected in common to the line pair located on the positive side in the Y direction thereof. Similarly, three pixel circuits 60 constituting the respective pixels Pix of the first group in the even rows (the center row in FIG. 33) and three pixel circuits 60 constituting the respective pixels Pix of the second group are connected to the line pairs located on the opposite sides in the Y direction thereof. According to this configuration, as shown in FIG. 33, since the configuration of the wiring portions 511 or the wiring portions 531 is simplified in the same manner as FIGS. 23 and 29, it is possible to obtain the same operations and advantages as the fourth embodiment.

### (5) Fifth Modified Example

The configuration of the pixel circuits 60 is not limited to the example shown in FIG. 3. For example, pixel circuits 60 of a voltage-driven type in which the gray scales of the light-emitting elements 63 are controlled by the voltages of the data lines 55 may be employed instead of the above-mentioned pixel circuits 60 of a current-driven type (in which the gray scales of the light-emitting elements 63 are controlled by the current of the data lines 55. In addition, the pixel circuits disclosed in JP-A-2000-221942 may be employed. In this configuration, the final period of the light-emission period is a blanking period (a period of time when the light-emitting elements 63 do not emit light).

### (6) Sixth Modified Example

In the above-mentioned embodiments, the OLED elements are exemplified as the light-emitting elements 63, but the light-emitting elements according to the invention are not limited to the OLED elements. For example, a variety of light-emitting elements such as inorganic EL elements, field emission (FE) elements, surface-conduction electron-emitter (SE) elements, ballistic electron surface emitting (BS) elements, light emitting diode (LED) elements can be used instead of the OLED elements.

### F: Applications

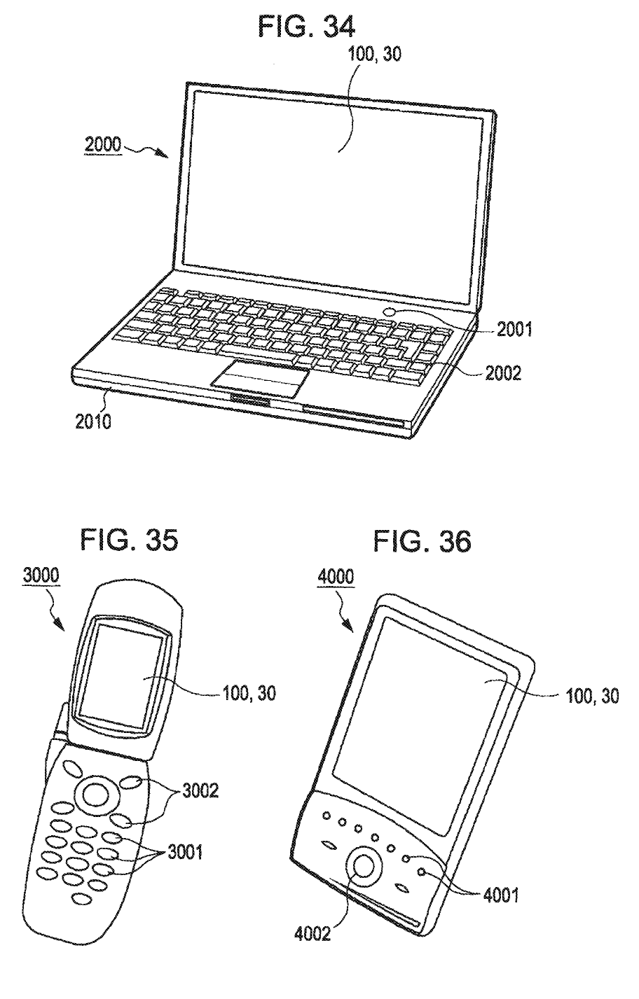

An electronic apparatus employing the light-emitting device according to the invention is described now. FIG. 34 is a perspective view illustrating a configuration of a mobile personal computer employing the light-emitting device 100 according to any one embodiment described above as a display unit. The personal computer 2000 includes the light-emitting device 100 as a display unit and a main body 2010. The main body 2010 is provided with a power supply switch 2001 and a keyboard 2002. Since a display panel 30 of the light-emitting device 100 employs OLED elements as light-emitting elements 63, it is possible to display an image with a wide viewing angle and excellent visibility.

FIG. 35 illustrates a configuration of a mobile phone employing the light-emitting device 100. The mobile phone 3000 includes a plurality of operation buttons 3001 and scroll buttons 3002 and a light-emitting device 100 as a display device. An image displayed on a display panel 30 of the light-emitting device 100 is scrolled by operating the scroll buttons 3002.

FIG. 36 illustrates a configuration of a personal digital assistant (PDA) employing the light-emitting device 100. The personal digital assistant 4000 includes a plurality of operation buttons 4001, a power supply switch 4002, and a light-emitting device 100 as a display device. Information such as an address list or a schedule pocketbook is displayed on a display panel 30 of the light-emitting device 100 by operating the power supply switch 4002.

In addition to those shown in FIGS. 34 to 36, examples of the electronic apparatus employing the light-emitting device 100 according to the invention can include a digital still camera, a television, a video camera, a car navigation apparatus, a radio pager, an electronic pocket book, an electronic paper, a calculator, a word processor, a work station, a television phone, a POS terminal, a printer, a scanner, a copier, a video player, an apparatus having a touch panel, and the like.

The entire disclosure of Japanese Patent Application Nos: 2005-169171, filed Jun. 9, 2005 and 2005-357270, filed Dec. 12, 2005 are expressly incorporated by reference herein.

What is claimed is:

1. A light-emitting device comprising:
a display unit in which a plurality of pixel circuits for allowing light-emitting elements to emit light with brightness corresponding to a data signal is arranged;
an image acquiring unit for acquiring a first image and a second image corresponding to times different from each other in a frame period of time, respectively;
a data-line driving unit for supplying a data signal corresponding to the first image to the pixel circuits belonging to a first group among the plurality of pixel circuits and supplying a data signal corresponding to the second image to the pixel circuits belonging to a second group other than the first group; and
a light-emission control unit for allowing the light-emitting elements of the pixel circuits belonging to the first group to emit light in a first period of the frame period of time and allowing the light-emitting elements of the pixel circuits belonging to the second group to emit light in a second period other than the first period of the frame period of time.

2. The light-emitting device according to claim 1, wherein the display unit is partitioned into a plurality of unit areas of which each includes a predetermined number of pixel circuits belonging to the first group and a predetermined number of pixel circuits belonging to the second group.

3. The light-emitting device according to claim 2, wherein the display unit has a configuration that a plurality of circuit groups, each of which include a predetermined number of pixel circuits arranged in a first direction, are arranged in a second direction intersecting the first direction,
wherein each unit area includes the circuit group belonging to the first group and the circuit group being adjacent to the circuit group and belonging to the second group, and
wherein the light-emission control unit allows the light-emitting elements of the pixel circuits to emit light or extinguish light by supplying a common light-emission control signal to the pixel circuits of one circuit group.

4. The light-emitting device according to claim 1, wherein the display unit has a configuration that a plurality of circuit groups, each of which includes a predetermined number of pixel circuits arranged in a first direction, are arranged in a second direction intersecting the first direction,
wherein the pixel circuits in the odd circuit groups among the plurality of circuit groups belong to the first group and the pixel circuits in the even circuit groups belong to the second group, and
wherein the light-emission control unit allows the light-emitting elements of the pixel circuits to emit light or extinguish light by supplying a common light-emission control signal to the pixel circuits of one circuit group.

5. The light-emitting device according to claim 1, wherein the display unit has a configuration that the plurality of pixel circuits are arranged in a first direction and a second direction intersecting each other, and
wherein the plurality of pixel circuits are partitioned into the groups so that the pixel circuits of the second group are adjacent to the pixel circuits of the first group in the first direction and the second direction.

6. The light-emitting device according to claim 1, wherein the display unit has a configuration that a plurality of circuit groups, each of which includes a predetermined number of pixel circuits arranged in a first direction, are arranged in a second direction intersecting the first direction,
wherein the pixel circuits of the first group in one circuit group among the plurality of circuit groups and the pixel circuits of the first group in a different group adjacent to the one circuit group are connected in common to a first light-emission control line, and the pixel circuits of the second group in the one circuit group and the pixel circuits of the second group in the different circuit group are connected in common to a second light-emission control line, and
wherein the light-emission control unit allows the light-emitting elements of the pixel circuits to emit light or extinguish light by supplying a common light-emission control signal through the first and second light-emission control lines.

7. The light-emitting device according to claim 1, wherein the display unit has a configuration that a plurality of line pairs, each of which includes a scanning line extending in a first direction and a light-emission control line extending in the first direction, are arranged in a second direction intersecting the first direction, and a circuit group including a predetermined number of pixel circuits arranged in the first direction is disposed between the line pairs adjacent to each other in the second direction,
wherein the pixel circuits of the first group in the respective circuit groups are connected to the scanning line and the light-emission control line of the line pair adjacent to one side in the second direction as seen from the circuit group side, and the pixel circuits of the second group are connected to the scanning line and the light-emission control line of the line pair adjacent to the other side in the second direction as seen from the circuit group,
wherein a selection unit for sequentially selecting the scanning lines is further provided,
wherein the data signal output from the data-line driving unit is supplied to the pixel circuits connected to the scanning line selected by the selection unit, and
wherein the light-emission control unit allows the light-emitting elements of the pixel circuits to emit light or extinguish light by supplying a light-emission control signal through the light-emission control lines.

8. The light-emitting device according to claim 7, wherein the data signal is supplied to the pixel circuits through data lines extending in the second direction on an insulating layer covering the scanning lines and the light-emission control lines,
wherein first wiring portions for electrically connecting the pixel circuits to the scanning lines and second wiring portions for electrically connecting the pixel circuits to the light-emission control lines are formed in the same layer as the data lines on the insulating layer, and
wherein the first wiring portions extend in the second direction in the pixel circuits and are electrically connected to the scanning lines through contact holes of the insulating layer, respectively, and the second wiring portions extend in the second direction in the pixel circuits and are electrically connected to the light-emission control lines through contact holes of the insulating layer.

9. The light-emitting device according to claim 1, wherein the data-line driving unit supplies the data signals to the pixel circuits of the first group at the time before the pixel circuits of the first group emit light in the first period, and supplies the data signals to the pixel circuits of the second group at the time before the pixel circuits of the second group emit light in the second period.

10. The light-emitting device according to claim 1, wherein the image acquiring unit comprises:
an intermediate image generator for generating an intermediate image from a first original image and a second original image which should be displayed in the successive frame periods of time; and
a controller for notifying the data-line driving unit of one of a plurality of images including the intermediate image generated by the intermediate image generator as the first image and notifying the data-line driving unit of another image as the second image.

11. An electronic apparatus comprising the light-emitting device according to claim 1.

12. A method of driving a light-emitting device in which a plurality of pixel circuits for allowing light-emitting elements to emit light with brightness corresponding to a data signal is arranged in a matrix shape, the method comprising:
acquiring a first image and a second image corresponding to times different from each other in a frame period of time, respectively;
supplying a data signal corresponding to the first image to the pixel circuits belonging to a first group among the plurality of pixel circuits and supplying a data signal corresponding to the second image to the pixel circuits belonging to a second group other than the first group; and
allowing the light-emitting elements of the pixel circuits belonging to the first group to emit light in a first period of the frame period of time and allowing the light-emitting elements of the pixel circuits belonging to the second group to emit light in a second period other than the first period of the frame period of time.
